(19) United States
(12) Patent Application Publication
(10) Pub. No.: US 2025/0148748 A1
(43) Pub. Date: May 8, 2025

(54) METHOD AND ELECTRONIC DEVICE FOR INTERACTIVE IMAGE SEGMENTATION

(71) Applicant: Samsung electronics Co., LTD., Suwon-si (KR)

(72) Inventors: Praful MATHUR, Bengaluru (IN); Shashi Kumar Parwani, Bengaluru (IN); Darshana Venkatesh Murthy, Bengaluru (IN); Roopa Kotiganahally Sheshadri, Bengaluru (IN); Aman Sharma, Bengaluru (IN); Veerendra K Shetty, Bengaluru (IN); Sunmin Park, Suwon-si (KR)

(73) Assignee: Samsung electronics Co., LTD., Suwon-si (KR)

(21) Appl. No.: 19/016,900

(22) Filed: Jan. 10, 2025

Related U.S. Application Data
(63) Continuation of application No. PCT/KR2020/009942, filed on Jul. 12, 2023.

(30) Foreign Application Priority Data
Jul. 12, 2022 (IN) 202241039917
Apr. 26, 2023 (IN) 202241039917

(51) Int. Cl. G06V 10/26; G06V 10/22; G06V 10/32; G06V 10/44; G06V 10/56; G06V 10/82

(52) U.S. Cl. CPC G06V 10/26; G06V 10/235; G06V 10/32; G06V 10/44; G06V 10/56; G06V 10/82

(57) ABSTRACT

Provided are a method and electronic device for interactive image segmentation. The method includes receiving one or more user inputs for segmenting at least one object from among a plurality of objects in an image. The method includes generating a unified guidance map indicates the at least one object to be segmented based on the one or more user inputs. The method includes generating a complex supervision image based on the unified guidance map. The method includes segmenting the at least one object from the image by passing the image, the complex supervision image and the unified guidance map through an adaptive Neural Network (NN) model. The method includes storing the at least one segmented object from the image. Further, the method include configuring the parameters of an adaptive Neural Network based on color complexity analysis, edge complexity analysis and geometry complexity analysis.

### CROSS-REFERENCE TO RELATED APPLICATIONS

This application is a bypass continuation application of International Application No. PCT/KR2023/009942, filed on Jul. 12, 2023, which is based on and claims priority to Indian Non-Provisional patent application No. 202241039917, filed on Apr. 26, 2023, and Indian Provisional Patent Application No. 202241039917, filed on Jul. 12, 2022, the disclosures of which are incorporated herein by reference in their entireties.

### BACKGROUND

### 1. Field

The present disclosure relates to image segmentation, and more specifically to a method and the electronic device for interactive image segmentation.

### 2. Description of Related Art

In image processing technology, object segmentation from an image is one of the operations performed for object erasing, object extraction, etc. Moreover, having interaction based object segmentation allows users to process the object of their interest. The interactive segmentation is very challenging since a number object classes/categories to be segmented may be unlimited. One of the goals of the interactive segmentation is to achieve best object segmentation accuracy with minimum user interactions. However, related art interaction-based segmentation solutions model multiple input methods (touch, contour, text, etc.) are tightly coupled with neural networks. Deploying heavy neural network architectures consumes a lot of memory and time. Also, the related art interaction-based segmentation solutions do not support segmentation of objects in multiple images simultaneously. Thus, it is desired to provide a useful alternative for interactive image segmentation.

### SUMMARY

Provided are a method and an electronic device for interactive image segmentation.

Further, provided is a dynamic neural network paradigm based on object complexity for the interactive image segmentation which will be more useful for devices with limited computing and storage resources.

Further, one or more embodiments may effectively segment an object from an image using multimodal user interactions and based on object complexity analysis.

According to an aspect of the disclosure, there is provided a method for interactive image segmentation by an electronic device, the method including: receiving one or more user inputs for segmenting at least one object from among a plurality of objects in an image; generating a unified guidance map that indicates the at least one object to be segmented based on the one or more user inputs; generating a complex supervision image based on the unified guidance map; segmenting the at least one object from the image by inputting the image, the complex supervision image and the unified guidance map into an adaptive Neural Network (NN) model; and storing the at least one segmented object from the image.

The generating the unified guidance map may include: extracting input data based on the one or more user inputs; obtaining one or more guidance maps corresponding to the one or more user inputs based on the input data; and generating the unified guidance map by concatenating the one or more guidance maps.

The obtaining the one or more guidance maps may include: based on the input data including one or more set of coordinates, obtaining traces of the one or more user inputs on the image using the input data; and encoding the traces into the one or more guidance maps, and wherein the traces represent user interaction locations on the image.

The obtaining the one or more guidance maps may include: based on the input data including text indicating the at least one object in the image, determining a segmentation mask based on a category of the text using an instance model; and converting the segmentation mask into the one or more guidance maps.

The determining the segmentation mask may include: based on the input data including an audio, converting the audio into the text; and determining the segmentation mask based on the category of the text using the instance model.

The generating the complex supervision image may include: determining a plurality of complexity parameters including at least one of a color complexity, an edge complexity or a geometry map of the at least one object to be segmented; and generating the complex supervision image by concatenating a weighted low frequency image obtained using the color complexity and the unified guidance map, a weighted high frequency image obtained using the edge complexity and the unified guidance map, and the geometry map.

The determining the color complexity of the at least one object may include: obtaining a low frequency image by inputting the image into a low pass filter; determining a weighted map by normalizing the unified guidance map; determining a weighted low frequency image by convolving the low frequency image with the weighted map; determining a standard deviation of the weighted low frequency image; determining whether the standard deviation of the weighted low frequency image is greater than a first threshold; and performing one of: detecting that the color complexity is high, based on the standard deviation of the weighted low frequency image being greater than the first threshold, and detecting that the color complexity is low, based on the standard deviation of the weighted low frequency image being less than or equal to the first threshold.

The determining the edge complexity of the at least one object may include: obtaining a high frequency image by inputting the image into a high pass filter; determining a weighted map by normalizing the unified guidance map; determining a weighted high frequency image by convolving the high frequency image with the weighted map; determining a standard deviation of the weighted high frequency image for analyzing the edge complexity; determining whether the standard deviation of the weighted high frequency image is greater than a second threshold; and performing one of: detecting that the edge complexity is high, based on the standard deviation of the weighted high frequency image being greater than the second threshold, and detecting that the edge complexity is low, based on the standard deviation of the weighted high frequency image being less than or equal to the second threshold.

The determining the geometry map of the at least one object may include: identifying a color at a location on the image; tracing the color within a reference range of color at the location; obtaining the geometry map including a union of the traced color with an edge map of the at least one object; and estimating a span of the at least one object by determining a size of a bounding box of the at least one object in the geometry map, and wherein the span corresponds to a larger side of the bounding box in a rectangle shape.

The segmenting the at least one object from the image may include: determining optimal scales for the adaptive NN model based on a relationship between a receptive field of the adaptive NN model and a span of the at least one object; determining an optimal number of layers for the adaptive NN model based on a color complexity; determining an optimal number of channels for the adaptive NN model based on an edge complexity; configuring the adaptive NN model based on the optimal scales, the optimal number of layers, and the optimal number of channels; and segmenting the at least one object from the image by inputting the image, the complex supervision image, and the unified guidance map through the configured adaptive NN model.

The determining the optimal scales may include: downscaling the image by a factor of two until the span of matches to the receptive field; and determining the optimal scales for the adaptive NN model based on a number of times the image has been downscaled to match the span with the receptive field.

The determining the optimal number of layers may include: performing one of: selecting a default number of layers as the optimal number of layers based on detecting a first color complexity in the image, and adding a reference layer offset value with the default number of layers for obtaining the optimal number of layers based on detecting a second color complexity, and wherein the first color complexity is lower than the second color complexity.

The determining the optimal number of channels may include: performing one of selecting a default number of channels as the optimal number of channels based on detecting a first edge complexity, and adding a reference channel offset value with the default number of channels for obtaining the optimal number of channels based on detecting a second edge complexity, and wherein the first edge complexity is lower than the second edge complexity.

According to another aspect of the disclosure, there is provided a method for encoding different types of user interactions by an electronic device, the method including: detecting a plurality of user inputs performed on an image; obtaining a plurality of guidance maps by converting each of the plurality of user inputs to one of the plurality of guidance maps based on a type of the respective user input; unifying the plurality of guidance maps to generate a unified guidance map representing a unified feature space; determining an object complexity based on the unified guidance map and the image; and inputting the object complexity and the image to an interactive segmentation engine.

The type of the user inputs may be at least one of a touch, a contour, a scribble, a stroke, text, an audio, an eye gaze, or an air gesture.

These and other aspects of the embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the embodiments, and the embodiments herein include all such modifications.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1A is a block diagram of an electronic device for interactive image segmentation, according to an embodiment of the disclosure;

FIG. 1B is a block diagram of an object segmentation mask generator for creating an object segmentation mask, according to an embodiment of the disclosure;

FIG. 2A is a flow diagram illustrating a method for the interactive image segmentation by the electronic device, according to an embodiment of the disclosure;

FIG. 2B is a flow diagram illustrating a method for encoding different types of user interactions into a unified feature space by the electronic device, according to an embodiment of the disclosure;

FIG. 2C is a flow diagram illustrating a method for determining an object complexity in an image based on user interactions by the electronic device, according to an embodiment of the disclosure;

FIG. 2D is a flow diagram illustrating a method for adaptively determining a number of scales, layers and channels for a NN model by the electronic device, according to an embodiment of the disclosure;

FIGS. 3A-3D illustrates various interactions of a user on images, according to an embodiment of the disclosure;

FIG. 3E illustrates an example scenario of generating a unified guidance map by a unified guidance map generator, according to an embodiment of the disclosure;

FIG. 4 illustrates an example scenario of analyzing object complexity by an object complexity analyzer, according to an embodiment of the disclosure;

FIG. 5A illustrates a method of performing the complexity analysis, and determining a complex supervision image by the object complexity analyzer, according to an embodiment of the disclosure;

FIGS. 5B-5D illustrate outputs of a color complexity analyzer, edge complexity analyzer, and a geometry complexity analyzer, according to an embodiment of the disclosure;

FIGS. 6A and 6B illustrate example scenarios of determining a weighted low frequency image, according to an embodiment of the disclosure;

FIGS. 7A and 7B illustrate example scenarios of determining a weighted high frequency image, according to an embodiment of the disclosure;

FIG. 8 illustrates example scenarios of determining a span of an object to segment, according to an embodiment of the disclosure;

FIG. 9 illustrates example scenarios of determining a complex supervision image based on color complexity analysis, edge complexity analysis and geometry complexity analysis, according to an embodiment of the disclosure;

FIG. 10A illustrates a schematic diagram of creating the object segmentation mask, according to an embodiment of the disclosure;

FIG. 10B illustrates an exemplary configuration of the NN model configurator, according to an embodiment of the disclosure;

FIGS. 11A-11C illustrate an example scenario of adaptively determining a number of scales in a hierarchical network based on the span of the object to be segmented, according to an embodiment of the disclosure;

FIGS. 12A and 12B illustrate example scenarios of the interactive image segmentation, according to an embodiment of the disclosure;

FIGS. 13-16 illustrate example scenarios of the interactive image segmentation, according to an embodiment of the disclosure; and

FIGS. 17A-17D illustrate comparison of related art segmentation results with interactive image segmentation results from a method according to an embodiment of the disclosure.

### DETAILED DESCRIPTION

Embodiments and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components, terms ending with “˜or” (e.g., “generator”), terms ending with “˜er” or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

According to an embodiment, there is provided a method for interactive image segmentation by an electronic device. The method includes receiving, by the electronic device, one or more user inputs for segmenting at least one object from among a plurality of objects in an image. The method includes generating, by the electronic device, a unified guidance map indicates the at least one object to be segmented based on the one or more user inputs. The method includes generating, by the electronic device, a complex supervision image based on the unified guidance map. The method includes segmenting, by the electronic device, the at least one object from the image by passing the image, the complex supervision image and the unified guidance map through an adaptive NN model. The method includes storing, by the electronic device, the at least one segmented object from the image.

According to an embodiment, there is provided a method for encoding different types of user interactions into the unified feature space by the electronic device. The method includes detecting, by the electronic device, multiple (or a plurality of) user inputs performed on the image. The method includes converting, by the electronic device, each user input to the guidance map based on the type of the user inputs. The method includes unifying, by the electronic device, all guidance maps obtained based on the multiple user inputs to generate the unified guidance map representing the unified feature space. The method includes determining, by the electronic device, the object complexity based on the unified guidance map and the image. The method includes feeding, by the electronic device, the object complexity and the image to the interactive segmentation engine.

According to an embodiment, there is provided a method for determining the object complexity in the image based on user interactions by the electronic device. The method includes decomposing, by the electronic device, the image into the low frequency image using the low pass filter, and the high frequency image using the high pass filter. The low frequency image represents the color map of the image, and the high frequency image represents the edge map of the image. The method includes determining, by the electronic device, the color complexity of the object by determining the weighted low frequency image from the low frequency image, and analyzing the standard deviation of the weighted low frequency image. The method includes determining, by the electronic device, the edge complexity of the object by determining the weighted high frequency image from the high frequency image, and analyzing the standard deviation of the weighted high frequency image. The method includes estimating, by the electronic device, the geometry map of the object by applying the color tracing starting with coordinates of the user interaction on the image. The method includes generating, by the electronic device, the complex supervision image by concatenating the weighted low frequency image, the weighted high frequency image, and the geometry map. The method includes providing, by the electronic device, the color complexity, the edge complexity and the geometry map to the NN model configurator for determining the optimal architecture of the adaptive NN model. The method includes feeding, by the electronic device, the complex supervision image to the adaptive NN model.

According to an embodiment, there is provided a method for adaptively determining the number of scales, layers and channels for the NN model by the electronic device. The method includes determining, by the electronic device, optimal scales for the NN model based on the relationship between the receptive field of the NN model and the span of the object in the image. The span refers to the larger side of the bounding box in the rectangle shape. The method includes determining, by the electronic device, the optimal number of layers for the NN model based on the color complexity of the object. The method includes determining, by the electronic device, the optimal number of channels for the NN model based on the edge complexity of the object.

According to an embodiment, there is provided an electronic device for the interactive image segmentation. The electronic device includes the object segmentation mask generator, the memory, the processor, where the object segmentation mask generator coupled to the memory and the processor. The object segmentation mask generator is configured for receiving one or more user inputs for segmenting at least one object from among the plurality of objects in the image. The object segmentation mask generator is configured for generating the unified guidance map indicates the at least one object to be segmented based on the one or more user inputs. The object segmentation mask generator is configured for generating the complex supervision image based on the unified guidance map. The object segmentation mask generator is configured for segmenting the at least one object from the image by passing the image, the complex supervision image and the unified guidance map through the adaptive NN model. The object segmentation mask generator is configured for storing the at least one segmented object from the image.

According to an embodiment, there is provided an electronic device for encoding different types of user interactions into the unified feature space. The electronic device includes the object segmentation mask generator, the memory, the processor, where the object segmentation mask generator coupled to the memory and the processor. The object segmentation mask generator is configured for detecting multiple user inputs performed on the image. The object segmentation mask generator is configured for converting each user input to the guidance map based on the type of the user inputs. The object segmentation mask generator is configured for unifying all guidance maps obtained based on the multiple user inputs to generate the unified guidance map representing the unified feature space. The object segmentation mask generator is configured for determining the object complexity based on the unified guidance map and the image. The object segmentation mask generator is configured for feeding the object complexity and the image to the interactive segmentation engine.

According to an embodiment, there is provided an electronic device for determining the object complexity in the image based on the user interactions. The electronic device includes the object segmentation mask generator, the memory, the processor, where the object segmentation mask generator coupled to the memory and the processor. The object segmentation mask generator is configured for decomposing the image into the low frequency image using the low pass filter, and the high frequency image using the high pass filter. The low frequency image represents the color map of the image, and the high frequency image represents the edge map of the image. The object segmentation mask generator is configured for determining the color complexity of the object by determining the weighted low frequency image from the low frequency image, and analyzing the standard deviation of the weighted low frequency image. The object segmentation mask generator is configured for determining the edge complexity of the object by determining the weighted high frequency image from the high frequency image, and analyzing the standard deviation of the weighted high frequency image. The object segmentation mask generator is configured for estimating the geometry map of the object by applying the color tracing starting with coordinates of the user interaction on the image. The object segmentation mask generator is configured for generating the complex supervision image by concatenating the weighted low frequency image, the weighted high frequency image, and the geometry map. The object segmentation mask generator is configured for providing the color complexity, the edge complexity and the geometry map to the NN model configurator for determining the optimal architecture of the adaptive NN model. The object segmentation mask generator is configured for feeding the complex supervision image to the adaptive NN model.

According to an embodiment, there is provided an electronic device for adaptively determining the number of scales, layers and channels for the model. The electronic device includes the object segmentation mask generator, the memory, the processor, where the object segmentation mask generator coupled to the memory and the processor. The object segmentation mask generator is configured for determining optimal scales for the NN model based on the relationship between the receptive field of the NN model and the span of the object in the image. The span refers to the larger side of the bounding box in the rectangle shape. The object segmentation mask generator is configured for determining the optimal number of layers for the NN model based on the color complexity of the object. The object segmentation mask generator is configured for determining the optimal number of channels for the NN model based on the edge complexity of the object.

According to an embodiment, there is provided an input processing engine is included in the electronic device, which unifies multiple forms of user interactions such as touch, contour, eye gaze, audio, text, etc. to clearly identify the object intended by the user to segment. Further, the electronic device analyzes an object complexity based on the user interaction. Outputs of complexity analyzer would be complexity analysis and complex supervision image. In the complexity analysis, the electronic device analyzes a color complexity, an edge complexity and a geometric complexity from the input image and the user interactions. Based on these analysis, the electronic device dynamically determines an optimal network architecture for object segmentation. The electronic device concatenates the output of the color complexity analysis, the edge complexity analysis and the geometry complexity analysis and provides as additional input to an interactive segmentation engine for complex supervision.

Unlike related art methods and systems, the method according to one or more embodiments of the disclosure extends input interactions beyond touch point and text like stroke, contour, eye gaze, air action and voice commands. All these different types of input interactions are encoded into a unified guidance map. Also, the electronic device analyses the image object for edge, color and geometry to produce a complex supervision image for a segmentation model. Along with the complex supervision image, the unified guidance map is fed to the segmentation model to achieve better segmentation.

In an example case in which low pass filter is applied to obtain low frequency component of the image, the method according to one or more embodiments of the disclosure may be adaptive to illumination variations.

Unlike related art methods and systems, the electronic device adaptively determines the number of scales of the network to be applied on images and guidance maps in hierarchical interactive segmentation based on span of the object. Also, the electronic device determines a width (number of channels in each layer) and depth (number of layers) of the network. Multi scale images and guidance maps are fed to model to improve segmentation results.

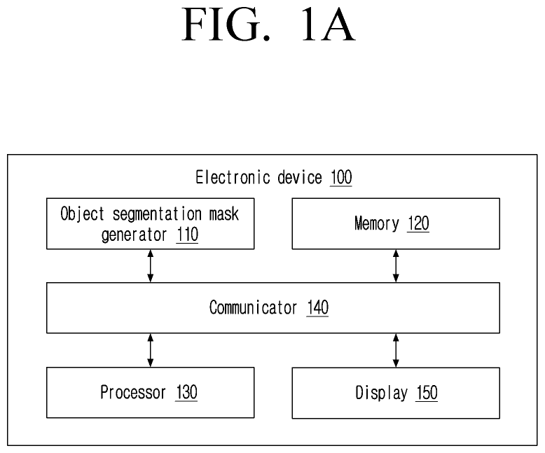

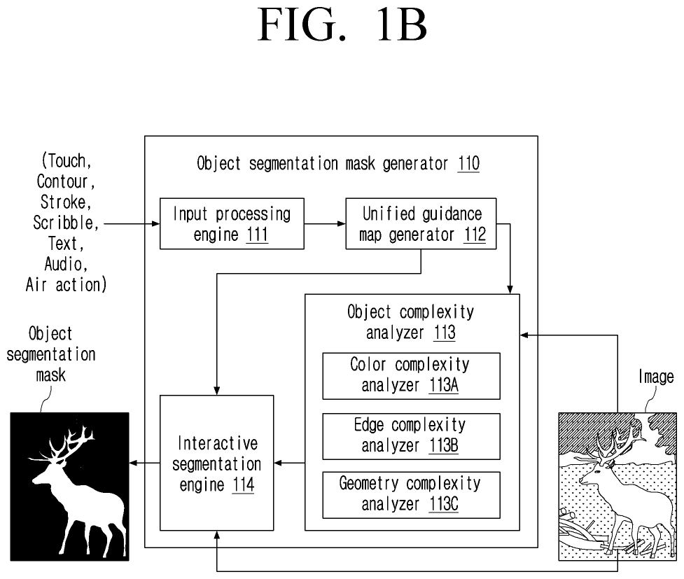

FIG. 1A is a block diagram of an electronic device (100) for interactive image segmentation, according to an embodiment of the disclosure. Examples of the electronic device (100) include, but are not limited to a smartphone, a tablet computer, a Personal Digital Assistance (PDA), a desktop computer, an Internet of Things (IoT), a wearable device, etc. In an embodiment, the electronic device (100) includes an object segmentation mask generator (110), a memory (120), a processor (130), a communicator (140), and a display (150), where the display is a physical hardware component that can be used to display to the image to a user. Examples of the display (150) include, but are not limited to a light emitting diode display, a liquid crystal display, etc. The object segmentation mask generator (110) is implemented by processing circuitry such as logic gates, integrated circuits, microprocessors, microcontrollers, memory circuits, passive electronic components, active electronic components, optical components, hardwired circuits, or the like, and may optionally be driven by a firmware. The circuits may, for example, be embodied in one or more semiconductor chips, or on substrate supports such as printed circuit boards and the like.

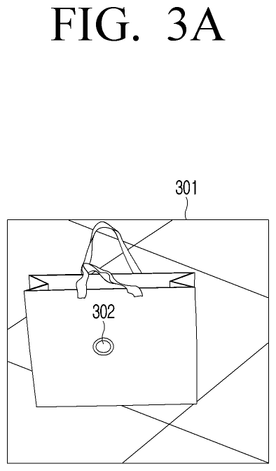

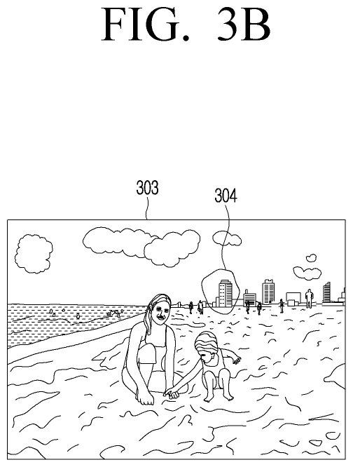

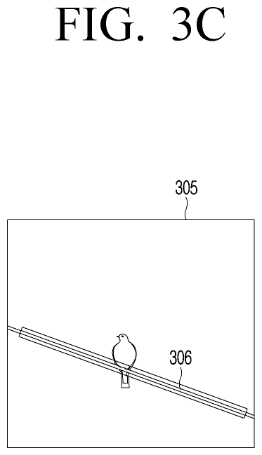

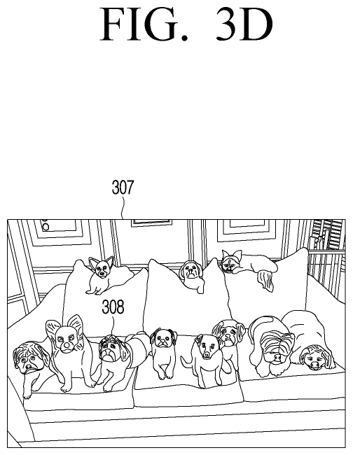

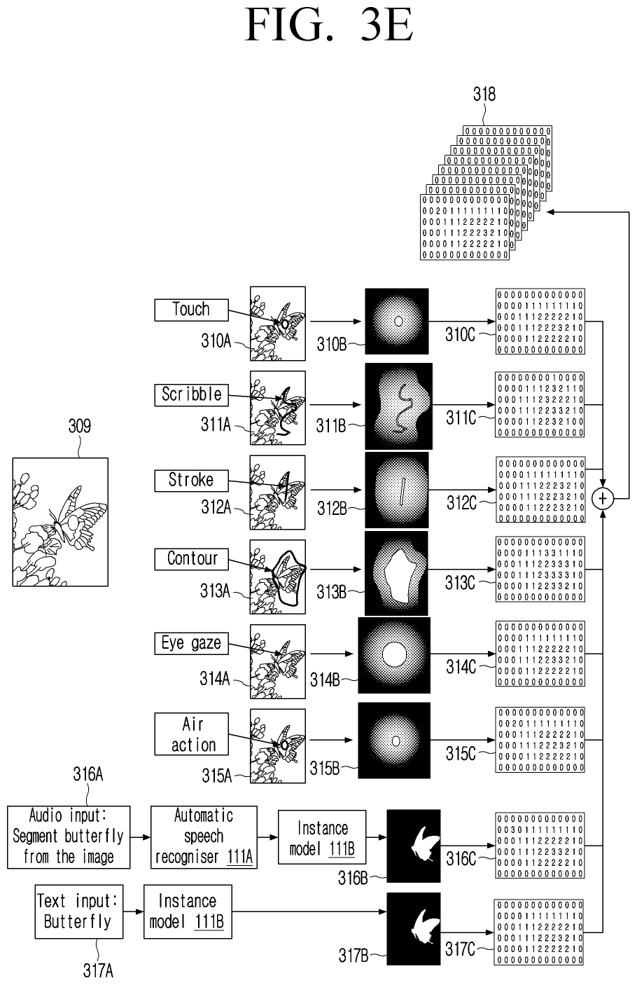

The object segmentation mask generator (110) receives one or more user inputs for segmenting one or more objects from among a plurality of objects in an image displayed by the electronic device (100). The one or more objects may include, but is not limited to, a car, a bird, kids, etc. Examples of the user input includes, but not limited to a touch input, a contour input, a scribble input, a stroke input, text input, an audio input, an eye gaze input, an air gesture input, etc. The object segmentation mask generator (110) generates a unified guidance map that indicates one or more objects to be segmented based on the one or more user inputs. The unified guidance map may also be referred to as a heat map. In an embodiment, the unified guidance map is a combined representation of individual guidance maps obtained through one or more user interactions. The guidance/heat map encodes the user input location in an image format. Such guidance map from each modality is concatenated to generate the unified guidance map (refer FIG. 3B).

The object segmentation mask generator (110) generates a complex supervision image based on the unified guidance map. In an embodiment, the complex super vision image is a combined representation of color complexity image, edge complexity image and geometric complexity image. For example, the complex super vision image may be a concatenated representation of the color complexity image, the edge complexity image and the geometric complexity image. The object segmentation mask generator (110) segments the one or more objects from the image by passing the image, the complex supervision image and the unified guidance map through an adaptive NN model. The object segmentation mask generator (110) stores the one or more segmented objects from the image.

In an embodiment, the object segmentation mask generator (110) extracts input data based on the one or more user inputs. In an embodiment, the user can use the device to provide multi-modal inputs such as line, contour, touch, text, audio etc. These inputs represent the object desired to be segmented. The inputs are converted to guidance maps based on Euclidian distance transform and processed further in the system.

The object segmentation mask generator (110) obtains guidance maps corresponding to the one or more user inputs based on the input data. In an embodiment, the guidance/heat map encodes the user input location in an image format. The object segmentation mask generator (110) generates the unified guidance map by concatenating the guidance maps obtained from one or more user inputs.

In an example case in which the input data includes one or more set of coordinates, the object segmentation mask generator (110) obtains traces of the one or more user inputs on the image using the input data according to an embodiment. The traces represent user interaction locations. The object segmentation mask generator (110) encodes the traces into the guidance maps. In an embodiment, in case of touch, there is single interaction point coordinate, in case of contour or line or scribble, there are multiple interaction coordinates represented by the boundary of lines, contour, scribble

In an example case in which the input data includes text indicating one or more objects in the image, the object segmentation mask generator (110) determines a segmentation mask based on a category (e.g. dogs, cars, food, etc.) of the text using an instance model according to an embodiment. The object segmentation mask generator (110) converts the segmentation mask into the guidance maps.

In an example case in which the input data includes audio, the object segmentation mask generator (110) converts the audio into text according to an embodiment. The text indicates the one or more objects in the image. The object segmentation mask generator (110) determines the segmentation mask based on the category of the text using the instance model

In an embodiment, the object segmentation mask generator (110) determines a plurality of complexity parameters. The plurality of complexity parameters may include, but is not limited to, a color complexity, an edge complexity and a geometry map of the one or more objects to be segmented. The object segmentation mask generator (110) may generate the complex supervision image by concatenating a weighted low frequency image obtained using the color complexity and the unified guidance map, a weighted high frequency image obtained using the edge complexity and the unified guidance map, and the geometry map. However, the disclosure is not limited thereto, and as such, according to another embodiment, the object segmentation mask generator (110) may generate the complex supervision image based on the plurality of complexity parameters in another manner.

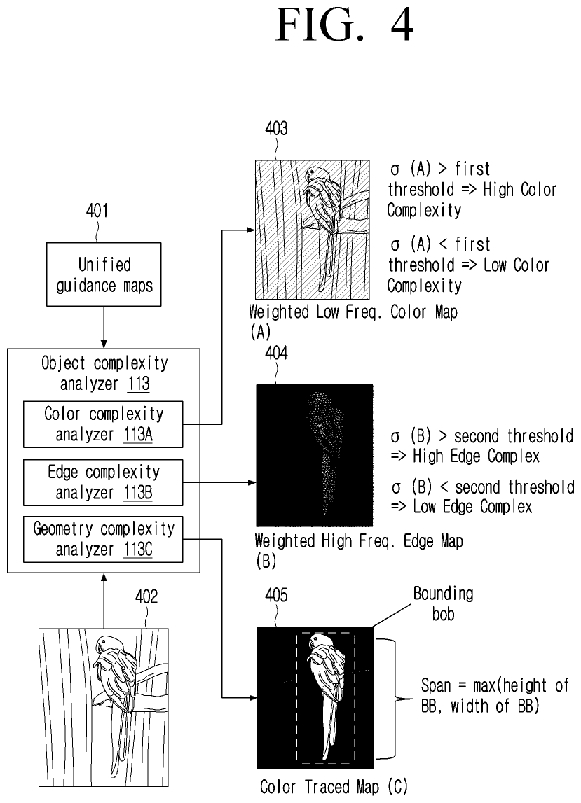

In an embodiment, the object segmentation mask generator (110) may obtain a low frequency image by passing the image through a low pass filter. For example, the object segmentation mask generator (110) may obtain the low frequency image by inputting the image through a low pass filter. The low frequency image may represent the color component in the image. The details of the low frequency image are explained in conjunction with the FIG. 4. The object segmentation mask generator (110) determines a weighted map by normalizing the unified guidance map. In an embodiment, the weighted map represents the normalized unified guidance map. The object segmentation mask generator (110) determines the weighted low frequency image by convolving the low frequency image with the weighted map. The object segmentation mask generator (110) determines a standard deviation of the weighted low frequency image. The object segmentation mask generator (110) determines whether the standard deviation of the weighted low frequency image is greater than a first threshold. The first threshold may be predefined or predetermined. The object segmentation mask generator (110) detecting that the color complexity is high, based on the standard deviation of the weighted low frequency image being greater than the first threshold. The object segmentation mask generator (110) detects that the color complexity is low, based on the standard deviation of the weighted low frequency image being not greater than the first threshold. For example, the object segmentation mask generator (110) may detect that the color complexity is low, based on the standard deviation of the weighted low frequency image being less than or equal to the first threshold.

In an embodiment, the object segmentation mask generator (110) may obtain a high frequency image by passing the image through a high pass filter. For example, the object segmentation mask generator (110) may obtain the high frequency image by inputting the image through a high pass filter. The high frequency image represents the edge characteristics of an image. The details of the high frequency image are described in conjunction with the FIG. 4B. The object segmentation mask generator (110) determines the weighted high frequency image by convolving the high frequency image with the weighted map. The object segmentation mask generator (110) determines a standard deviation of the weighted high frequency image for analyzing the edge complexity. The object segmentation mask generator (110) determines whether the standard deviation of the weighted high frequency image is greater than a second threshold. The second threshold may be predefined or predetermined. The object segmentation mask generator (110) detects that the edge complexity is high, based on the standard deviation of the weighted high frequency image being greater than the second threshold. The object segmentation mask generator (110) detects that the edge complexity is low, based on the standard deviation of the weighted high frequency image being not greater than the second threshold. For example, the object segmentation mask generator (110) detects that the edge complexity is low, based on the standard deviation of the weighted high frequency image being less than or equal to the second threshold.

In an embodiment, the object segmentation mask generator (110) identifies a color at a location on the image where the user input is received. The object segmentation mask generator (110) traces the color within a reference range of color at the location. For example, he object segmentation mask generator (110) traces the color within a predetermined range of color at the location. The object segmentation mask generator (110) obtains a geometry map includes a union of the traced color with an edge map of the one or more objects. In an embodiment, the geometry map represents the estimated geometry/shape of object to be segmented. The geometry map is obtained by tracing the colors in some predefined range starting from point of user interaction. In an embodiment, the edge map is obtained by multiplying high frequency image with weighted guidance map

The object segmentation mask generator (110) estimates the span of the one or more objects by determining a size of bounding box of the one or more objects in the geometry map. For example, the span may refer to a larger side of the bounding box in a rectangle shape.

In an embodiment, the object segmentation mask generator (110) determines optimal scales for the adaptive NN model based on a relationship between a receptive field of the adaptive NN model and a span of the one or more objects. The object segmentation mask generator (110) determines an optimal number of layers for the adaptive NN model based on the color complexity. The object segmentation mask generator (110) determines an optimal number of channels for the adaptive NN model based on the edge complexity. The object segmentation mask generator (110) configures the adaptive NN model based on the optimal scales, the optimal number of layers, and the optimal number of channels. The dynamic modification of the adaptive NN model based on the object complexity analysis provides improvement in inference time and the memory (120) as compared to baseline architecture with full configuration for multiple user interactions like touch, contour, etc. The object segmentation mask generator (110) segments the one or more objects from the image by passing the image, the complex supervision image, and the unified guidance map through the configured adaptive NN model.

In an embodiment, the object segmentation mask generator (110) downscales the image by a factor of two till the span of matches to the receptive field. The object segmentation mask generator (110) determines the optimal scales for the adaptive NN model based on a number of times the image has been downscaled to match the span with the receptive field.

In an embodiment, the object segmentation mask generator (110) selects a default number of layers (for example, 5 layers) as the optimal number of layers, upon detecting the lower color complexity. The object segmentation mask generator (110) utilizes a predefined layer offset value (for example, a layer offset value of 2), and adds the predefined layer offset value with the default number of layers for obtaining the optimal number of layers, upon detecting the higher color complexity.

In an embodiment, the object segmentation mask generator (110) selects a default number of channels (for example, 128 channels) as the optimal number of channels, upon detecting the lower edge complexity. The object segmentation mask generator (110) utilizes a predefined channel offset value (for example, 16 channels as offset value), and adds the predefined channel offset value with the default number of channels for obtaining the optimal number of channels, upon detecting the higher edge complexity.

The memory (120) stores the image, and the segmented object. The memory (120) stores instructions to be executed by the processor (130). The memory (120) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (120) may, in some examples, be considered a non-transitory storage medium. The term “non-transitory” may indicate that the storage medium is not embodied in a carrier wave or a propagated signal. However, the term “non-transitory” should not be interpreted that the memory (120) is non-movable. In some examples, the memory (120) can be configured to store larger amounts of information than its storage space. In certain examples, a non-transitory storage medium may store data that can, over time, change (e.g., in Random Access Memory (RAM) or cache). The memory (120) can be an internal storage unit or it can be an external storage unit of the electronic device (100), a cloud storage, or any other type of external storage.

The processor (130) is configured to execute instructions stored in the memory (120). The processor (130) may be a general-purpose processor, such as a Central Processing Unit (CPU), an Application Processor (AP), or the like, a graphics-only processing unit such as a Graphics Processing Unit (GPU), a Visual Processing Unit (VPU) and the like. The processor (130) may include multiple cores to execute the instructions. The communicator (140) is configured for communicating internally between hardware components in the electronic device (100). Further, the communicator (140) is configured to facilitate the communication between the electronic device (100) and other devices via one or more networks (e.g. Radio technology). The communicator (140) includes an electronic circuit specific to a standard that enables wired or wireless communication.

A function associated with NN model may be performed through the non-volatile/volatile memory (120), and the processor (130). The one or a plurality of processors (130) control the processing of the input data in accordance with a predefined operating rule or the NN model stored in the non-volatile/volatile memory (120). The predefined operating rule or the NN model is provided through training or learning. Here, being provided through learning means that, by applying a learning method to a plurality of learning data, the predefined operating rule or the NN model of a desired characteristic is made. The learning may be performed in the electronic device (100) itself in which the NN model according to an embodiment is performed, and/or may be implemented through a separate server/system. The NN model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks. The learning method is a method for training a predetermined target device (for example, a robot) using a plurality of learning data to cause, allow, or control the target device to make a determination or prediction. Examples of the learning method include, but are not limited to, supervised learning, unsupervised learning, semi-supervised learning, or reinforcement learning.

Although the FIG. 1 shows the hardware components of the electronic device (100) but it is to be understood that other embodiments are not limited thereon. In other embodiments, the electronic device (100) may include less or a greater number of components. Further, the labels or names of the components are used only for illustrative purpose and does not limit the scope of the disclosure. One or more components can be combined together to perform same or substantially similar function for the interactive image segmentation.

FIG. 1B is a block diagram of the object segmentation mask generator (110) for creating the object segmentation mask, according to an embodiment of the disclosure. In an embodiment, the object segmentation mask generator (110) includes an input processing engine (111), a unified guidance map generator (112), an object complexity analyzer (113), and an interactive segmentation engine (114). c includes a color complexity analyzer (113A), an edge complexity analyzer (113B), and a geometry complexity analyzer (113C). The input processing engine (111) includes an automatic speech recognizer, and the instance model (not shown). The interactive segmentation engine (114) includes a NN model configurator (not shown). The input processing engine (111), the unified guidance map generator (112), the object complexity analyzer (113), and the interactive segmentation engine (114) are implemented by processing circuitry such as logic gates, integrated circuits, microprocessors, microcontrollers, memory circuits, passive electronic components, active electronic components, optical components, hardwired circuits, or the like, and may optionally be driven by a firmware. The circuits may, for example, be embodied in one or more semiconductor chips, or on substrate supports such as printed circuit boards and the like.

The input processing engine (111) receives the one or more user inputs for segmenting one or more objects from among the plurality of objects in the image displayed by the electronic device (100). The unified guidance map generator (112) generates the unified guidance map indicates the one or more objects to be segmented based on the one or more user inputs. The object complexity analyzer (113) generates a complex supervision image based on the unified guidance map. The interactive segmentation engine (114) segments the one or more objects from the image by passing the image, the complex supervision image and the unified guidance map through the adaptive NN model. The interactive segmentation engine (114) stores the one or more segmented objects from the image.

In an embodiment, the input processing engine (111) extracts the input data based on the one or more user inputs. The unified guidance map generator (112) obtains the guidance maps corresponding to the one or more user inputs based on the input data. The unified guidance map generator (112) generates the unified guidance map by concatenating the guidance maps obtained from one or more user inputs.

In an example case in which the input data includes one or more set of coordinates, the input processing engine (111) obtains the traces of the one or more user inputs on the image using the input data according to an embodiment. The unified guidance map generator (112) encodes the traces into the guidance maps.

In an example case in which the input data includes text indicating one or more objects in the image, the input processing engine (111) determines the segmentation mask based on the category of the text using the instance model according to an embodiment. The unified guidance map generator (112) converts the segmentation mask into the guidance maps.

In an example case in which the input data includes audio, the automatic speech recognizer converts the audio into the text according to an embodiment. The text indicates the one or more objects in the image. The unified guidance map generator (112) determines the segmentation mask based on the category of the text using the instance model.

In an embodiment, the object complexity analyzer (113) determines the plurality of complexity parameters includes, but is not limited to, the color complexity, the edge complexity and the geometry map of the one or more objects to be segmented. The object complexity analyzer (113) generates the complex supervision image by concatenating the weighted low frequency image obtained using the color complexity and the unified guidance map, the weighted high frequency image obtained using the edge complexity and the unified guidance map, and the geometry map.

In an embodiment, the color complexity analyzer (113A) obtains the low frequency image by passing the image through the low pass filter. The color complexity analyzer (113A) determines the weighted map by normalizing the unified guidance map. The color complexity analyzer (113A) determines the weighted low frequency image by convolving the low frequency image with the weighted map. The color complexity analyzer (113A) determines the standard deviation of the weighted low frequency image. The color complexity analyzer (113A) determines whether the standard deviation of the weighted low frequency image is greater than the first threshold. The color complexity analyzer (113A) detects that the color complexity is high, based on the standard deviation of the weighted low frequency image being greater than the first threshold. The color complexity analyzer (113A) detects that the color complexity is low, based on the standard deviation of the weighted low frequency image being not greater than the first threshold.

In an embodiment, the edge complexity analyzer (113B) obtains the high frequency image by passing the image through the high pass filter. The edge complexity analyzer (113B) determines the weighted high frequency image by convolving the high frequency image with the weighted map. The edge complexity analyzer (113B) determines the standard deviation of the weighted high frequency image for analyzing the edge complexity. The edge complexity analyzer (113B) determines whether the standard deviation of the weighted high frequency image is greater than the second threshold. The edge complexity analyzer (113B) detects that the edge complexity is high, based on the standard deviation of the weighted high frequency image being greater than the second threshold. The edge complexity analyzer (113B) detects that the edge complexity is low, based on the standard deviation of the weighted high frequency image being not greater than the second threshold.

In an embodiment, the geometry complexity analyzer (113C) identifies the color at the location on the image where the user input is received. The geometry complexity analyzer (113C) traces the color within the predefined range of color at the location. The geometry complexity analyzer (113C) obtains the geometry map includes the union of the traced color with the edge map of the one or more objects. The geometry complexity analyzer (113C) estimates the span of the one or more objects by determining the size of bounding box of the one or more objects in the geometry map. For example, the span may refer to the larger side of the bounding box in the rectangle shape.

In an embodiment, the interactive segmentation engine (114) determines the optimal scales for the adaptive NN model based on the relationship between the receptive field of the adaptive NN model and the span of the one or more objects. The interactive segmentation engine (114) determines the optimal number of layers for the adaptive NN model based on the color complexity. The interactive segmentation engine (114) determines the optimal number of channels for the adaptive NN model based on the edge complexity. The NN model configurator configures the adaptive NN model based on the optimal scales, the optimal number of layers, and the optimal number of channels. The interactive segmentation engine (114) segments the one or more objects from the image by passing the image, the complex supervision image, and the unified guidance map through the configured adaptive NN model.

In an embodiment, the geometry complexity analyzer (113C) downscales the image by the factor of two till the span of matches to the receptive field. The interactive segmentation engine (114) determines the optimal scales for the adaptive NN model based on the number of times the image has been downscaled to match the span with the receptive field.

In an embodiment, the interactive segmentation engine (114) selects the default number of layers as the optimal number of layers, upon detecting the lower color complexity. The interactive segmentation engine (114) utilizes the predefined layer offset value, and adds the predefined layer offset value with the default number of layers for obtaining the optimal number of layers, upon detecting the higher color complexity.

In an embodiment, the interactive segmentation engine (114) selects the default number of channels as the optimal number of channels, upon detecting the lower edge complexity. The interactive segmentation engine (114) utilizes the predefined channel offset value, and adds the predefined channel offset value with the default number of channels for obtaining the optimal number of channels, upon detecting the higher edge complexity.

In another embodiment, the input processing engine (111) detects the multiple user inputs performed on the image displayed by the electronic device (100). The unified guidance map generator (112) converts each user input to the guidance map based on a type of the user inputs. The unified guidance map generator (112) unifies all guidance maps obtained based on the multiple user inputs to generate the unified guidance map representing the unified feature space. The object complexity analyzer (113) determines the object complexity based on the unified guidance map and the image. The object complexity analyzer (113) feeds the object complexity and the image to the interactive segmentation engine (114).

In another embodiment, the object complexity analyzer (113) decomposes the image into the low frequency image using the low pass filter, and the high frequency image using the high pass filter. For example, the low frequency image may represent a color map of the image, and the high frequency image may represent an edge map of the image. The color complexity analyzer (113A) determines the color complexity of the object by determining the weighted low frequency image from the low frequency image, and analyzing the standard deviation of the weighted low frequency image. The edge complexity analyzer (113B), determines the edge complexity of the object by determining the weighted high frequency image from the high frequency image, and analyzing the standard deviation of the weighted high frequency image. The geometry complexity analyzer (113C) estimates the geometry map of the object by applying the color tracing starting with coordinates of the user interaction on the image. The object complexity analyzer (113) generates the complex supervision image by concatenating the weighted low frequency image, the weighted high frequency image, and the geometry map. The object complexity analyzer (113) provides the color complexity, the edge complexity and the geometry map to the NN model configurator for determining an optimal architecture of the adaptive NN model. The object complexity analyzer (113) feeds the complex supervision image to the adaptive NN model.

Although the FIG. 1B shows the hardware components of the object segmentation mask generator (110) but it is to be understood that other embodiments are not limited thereon. In other embodiments, the object segmentation mask generator (110) may include less or a greater number of components. Further, the labels or names of the components are used only for illustrative purpose and does not limit the scope of the disclosure. One or more components can be combined together to perform same or substantially similar function for creating the object segmentation mask.

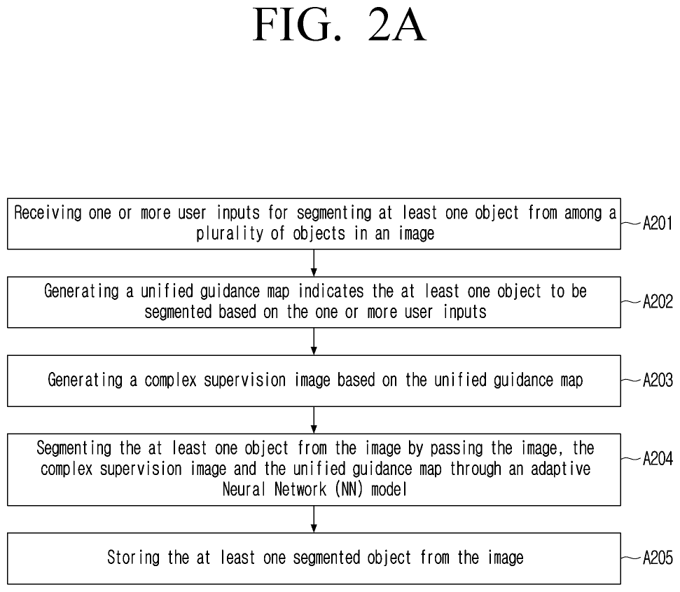

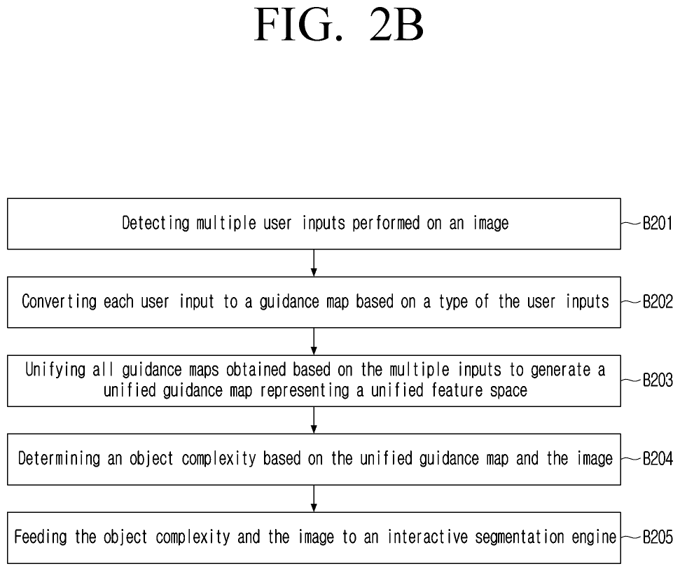

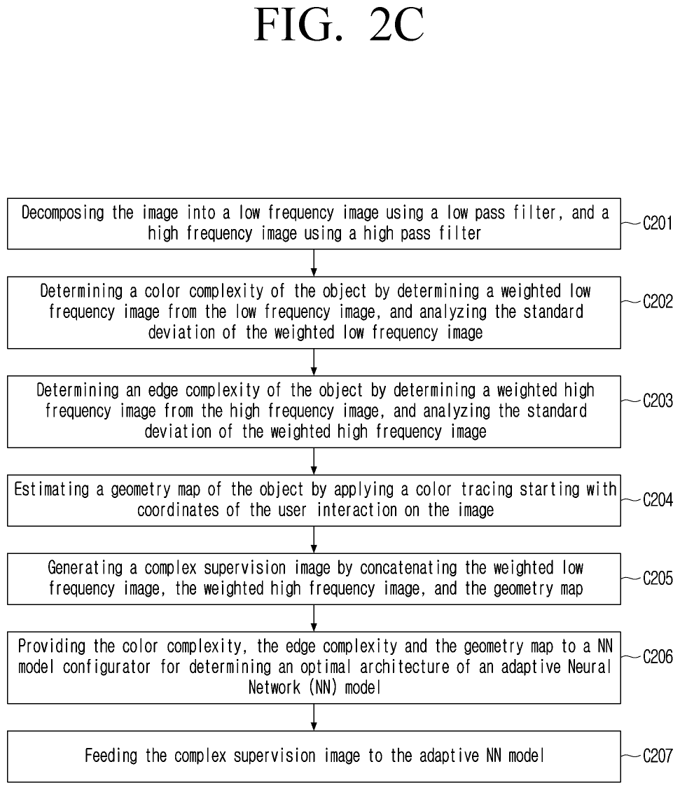

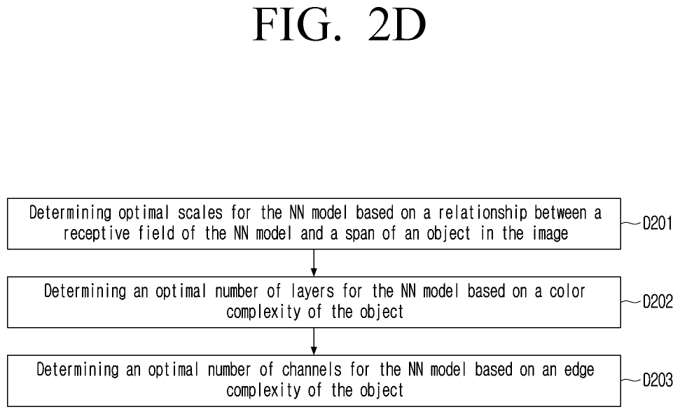

FIG. 2A is a flow diagram illustrating a method for the interactive image segmentation by the electronic device (100), according to an embodiment of the disclosure. In an embodiment, the method allows the object segmentation mask generator (110) to perform operations A201-A205 of the flow diagram. In operation A201, the method includes receiving the one or more user inputs for segmenting one or more objects from among the plurality of objects in the image. In operation A202, the method includes generating the unified guidance map indicates the one or more objects to be segmented based on the one or more user inputs. In operation A203, the method includes generating the complex supervision image based on the unified guidance map. In operation A204, the method includes segmenting the one or more objects from the image by passing (or inputting) the image, the complex supervision image and the unified guidance map through the adaptive NN model. In operation A205, the method includes storing the at least one segmented object from the image.

FIG. 2B is a flow diagram illustrating a method for encoding different types of user interactions into the unified feature space by the electronic device (100), according to an embodiment of the disclosure. In an embodiment, the method allows the object segmentation mask generator (110) to perform operations B201-B205 of the flow diagram. In operation B201, the method includes detecting the multiple user inputs performed on the image. In operation B202, the method includes converting each user input to the guidance map based on the type of the user inputs. In operation B203, the method includes unifying all guidance maps obtained based on the multiple user inputs to generate the unified guidance map representing the unified feature space. In operation B204, the method includes determining the object complexity based on the unified guidance map and the image. In operation B205, the method includes feeding the object complexity and the image to the interactive segmentation engine.

FIG. 2C is a flow diagram illustrating a method for determining the object complexity in the image based on the user interactions by the electronic device (100), according to an embodiment of the disclosure. In an embodiment, the method allows the object segmentation mask generator (110) to perform operations C201-C207 of the flow diagram. In operation C201, the method includes decomposing the image into the low frequency image using the low pass filter, and the high frequency image using the high pass filter. The low frequency image represents the color map of the image, and the high frequency image represents the edge map of the image. In operation C202, the method includes determining the color complexity of the object by determining the weighted low frequency image from the low frequency image, and analyzing the standard deviation of the weighted low frequency image.

In operation C203, the method includes determining the edge complexity of the object by determining the weighted high frequency image from the high frequency image, and analyzing the standard deviation of the weighted high frequency image. In operation C204, the method includes estimating the geometry map of the object by applying the color tracing starting with coordinates of the user interaction on the image. In operation C205, the method includes generating the complex supervision image by concatenating the weighted low frequency image, the weighted high frequency image, and the geometry map. In operation C206, the method includes providing the color complexity, the edge complexity and the geometry map to the NN model configurator for determining the optimal architecture of the adaptive NN model. In operation C207, the method includes feeding the complex supervision image to the adaptive NN model.

FIG. 2D is a flow diagram (illustrating a method for adaptively determining the number of scales, layers and channels for the NN model by the electronic device (100), according to an embodiment of the disclosure. In an embodiment, the method allows the object segmentation mask generator (110) to perform operations D201-D203 of the flow diagram. In operation D201, the method includes determining optimal scales for the NN model based on the relationship between the receptive field of the NN model and the span of the object in the image. The span refers to the larger side of the bounding box in the rectangle shape. In operation D202, the method includes determining the optimal number of layers for the NN model based on the color complexity of the object. In operation D203, the method includes determining the optimal number of channels for the NN model based on the edge complexity of the object.

The various actions, acts, blocks, operations, steps, or the like in the flow diagrams in FIGS. 2A-2D may be performed in the order presented, in a different order, or simultaneously. Further, in some embodiments, some of the actions, acts, blocks, operations, steps, or the like may be omitted, added, modified, skipped, or the like without departing from the scope of the disclosure.

FIGS. 3A-3D illustrate various interactions of the user on the images, according to an embodiment of the disclosure. For example, multiple modes of user interactions provide more flexibility and convenience to the user to select objects of different size and proportions. As shown in image 301 of FIG. 3A, in an example case in which the object is large and clearly visible in the image, the touch based UI is most convenient to select the object. In FIG. 3A, element 302 represents the click interaction of the user on the object (e.g. bag) in the image shown in 301 for object segmentation.

As shown in image 303 of FIG. 3B, in an example case in which the object is very small/complex shape, drawing a contour is more convenient or more suitable. In FIG. 3B, element 304 represents the contour interaction of the user on the object in the image shown in image 303 for object segmentation. For example, element 304 may corresponding to a marking or annotation of the user on an object, such as a building.

As shown in image 305 of FIG. 3C, in an example case in which the objects are thin and long (e.g., a stick), a stroke based interaction is more convenient or more suitable. In FIG. 3C, element 306 represents the stroke interaction of the user on the object (e.g. rope) in the image shown in 305 for object segmentation.

As shown in image 307 of FIG. 3D, in an example case in which there are multiple same category objects in the image, and the user wants to select all the objects at once, a text/audio based UI is more convenient or more suitable. In 3D, element 308 represents the object (e.g. dog) in the image shown in 307, in which the user interacts with the electronic device (100) by providing an audio or text input to the electronic device (100) to select the object (e.g. dog) for segmentation.

FIG. 3E illustrates an example scenario of generating a unified guidance map by the unified guidance map generator (112), according to an embodiment of the disclosure. For example, the electronic device (100) may display an image (309) as shown in FIG. 3E. Further, the user interacts with the displayed image (309) displayed by touching (310A) on the object to segment, scribbling (311A) on the object to segment, stroking (312A) on the object to segment, drawings a contour (313A) on the object to segment, eye gazing (314A) on the object to segment, performing an gesture/action (315A) in air over the electronic device (100) and/or providing an audio input (316A) and/or providing a text input (317A) to the electronic device (100). For example, the audio input (316A) may include an utterance “segment butterfly from the image”. For example, butterfly is the object to segment in the image (309). The text input (317A) may include a text “butterfly”, where butterfly is the object to segment in the image (309). The electronic device (100) converts the audio input to text using the automatic speech recognizer (111A).

The instance model (111B) of the electronic device (100) detects a category of the text received from the user or the automatic speech recognizer (111A), and generates a segmentation mask based on the category of the text. Upon receiving multiple user inputs, the electronic device (100) extracts the input data based on the multiple user inputs. In an embodiment, the electronic device (100) extracts data points (input data) from the user input (e.g. touch, contour, stroke, scribble, eye gaze, air action, etc.). For example, the data points may be in a form of one or more set of coordinates. Further, the electronic device (100) obtains the click maps from them based on the touch coordinates.

In the example scenario, item 310B represents the input data extracted from the touch input (310A), item 311B represents the input data extracted from the scribble input (311A), 312B represents the input data extracted from the stroke input (312A), item 313B represents the input data extracted from the contour input (313A), item 314B represents the input data extracted from the eye gaze input (314A), and item 315B represents the input data extracted from the air gesture/action input (315A). Item 316B represents the segmentation mask generated for the audio input (316A), 317B represents the segmentation mask generated for the text input (317A).

Further, the electronic device (100) obtains the guidance map corresponding to each user input based on the input data or the segmentation mask. In the example scenario, items 310C-317C represents the guidance map corresponding to each user input based on the input data/segmentation mask (items 310B-317B) respectively. In an embodiment, the electronic device (100) encodes the click maps into distance map (i.e. guidance map) using a Euclidean distance formula given below.

$$d ( p , q ) = \sqrt{{\sum }_{i = 1}^{n} {( {q}_{i} - {p}_{i} )}^{2}}$$

In this formula, p and 1 are two points in Euclidean n-space, pi and qi are Euclidean vectors, starting from the origin of the space (initial point) and n is n-space, where in is an integer.

Further, the electronic device (100) unifies all the guidance maps (310C-317C) obtained based on the multiple user inputs and generates the unified guidance map (318) representing the unified feature space.

FIG. 4 illustrates an example scenario of analyzing the object complexity by the object complexity analyzer (113), according to an embodiment of the disclosure. The object complexity includes the color complexity, the edge complexity, and the geometry map of the object. Upon receiving the unified guidance maps (401) and the image (402) by the object complexity analyzer (113), the color complexity analyzer (113A) of the object complexity analyzer (113) determines the standard deviation of the weighted low frequency image (403) (i.e. weighted low freq. color map (A) of the image (402)) using the unified guidance maps (401). Further, the color complexity analyzer (113A) determines whether the standard deviation of the weighted low frequency image (i.e. σ (A)) is greater than the first threshold. The color complexity analyzer (113A) detects that the color complexity is higher based on the standard deviation of the weighted low frequency image being greater than the first threshold, else detects that the color complexity is low.

Upon receiving the unified guidance maps (401) and the image (402) by the object complexity analyzer (113), the edge complexity analyzer (113B) determines the standard deviation of the weighted high frequency image for analyzing the edge complexity. Further, the edge complexity analyzer (113B) determines whether the standard deviation of the weighted high frequency image (404) (i.e. weighted high freq. edge map (B) of the image (402)) is greater than the second threshold using the unified guidance maps (401). The edge complexity analyzer (113B) detects that the edge complexity is high based on the standard deviation of the weighted high frequency image (i.e. σ (B)) being greater than the second threshold, else detects that the edge complexity is low.

Upon receiving the unified guidance maps (401) and the image (402) by the object complexity analyzer (113), the geometry complexity analyzer (113C) estimates the span of the object by determining a maximum height of Bounding Box (BB) or a maximum width of the BB in a color traced map (405) of the image.

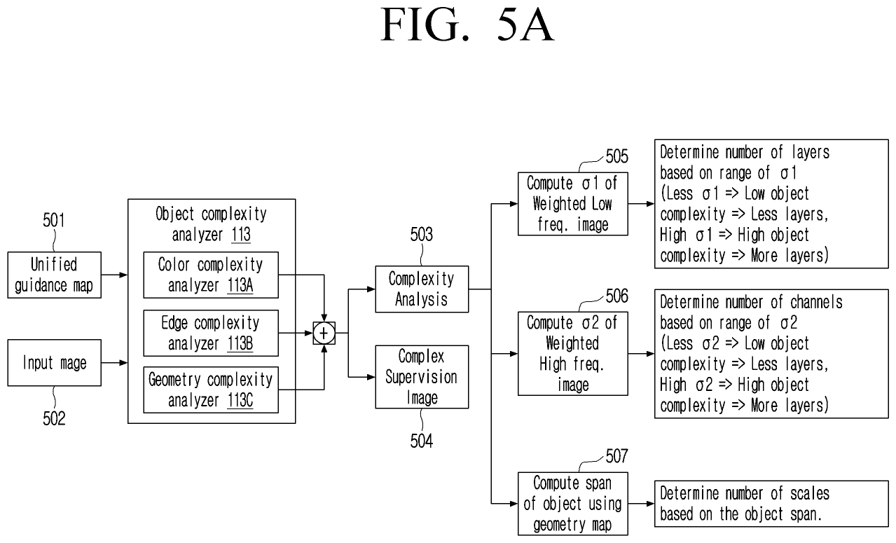

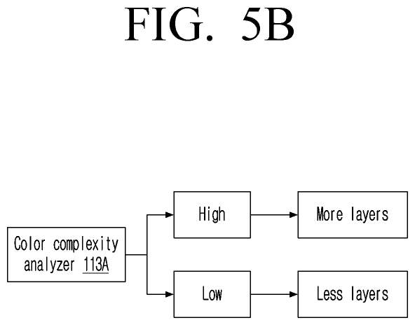

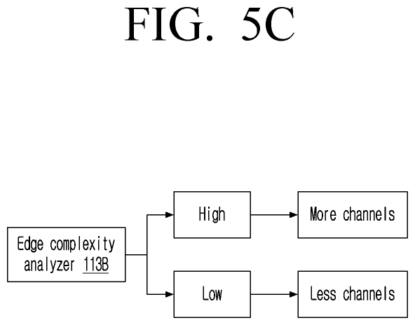

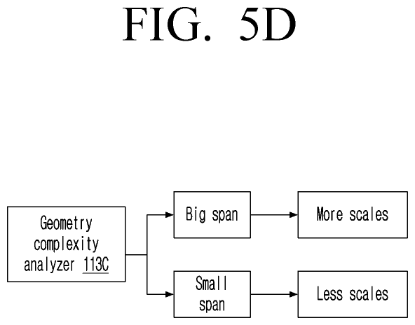

FIG. 5A illustrates a method of performing the complexity analysis, and determining the complex supervision image by the object complexity analyzer (113), according to an embodiment of the disclosure. The object complexity analyzer (113) determines the plurality of complexity parameters (503) includes the color complexity, the edge complexity and the geometry map of the object to be segmented upon receiving the image (502) and the unified guidance map (501).

Also, the object complexity analyzer (113) generates the complex supervision image by concatenating the weighted low frequency image obtained using the color complexity and the unified guidance map (501), the weighted high frequency image obtained using the edge complexity and the unified guidance map (501), and the geometry map. Upon determining the plurality of complexity parameters, the object complexity analyzer (113) determines the standard deviation (61) of the weighted low frequency image (505), and the standard deviation (62) of the weighted high frequency image (506), and determines the span (507) of the object using the geometry map. The object complexity analyzer (113) determines the number of layers based on the predefined range of σ (i.e. Less σ1=>Low object complexity=>Less layers, and High σ1=>High object complexity=>More layers). The object complexity analyzer (113) determines the number of channels based on the predefined range of σ2 (i.e. Less σ2=>Low object complexity=>Less layers, and High σ2=>High object complexity=>More layers). σ1 is equal to σ (A), and σ2 is equal to σ (B).

In an embodiment, the object complexity analyzer (113) decomposes the image into the low frequency component representing the color map and the high frequency component representing the edge map of the input image. Further, the object complexity analyzer (113) determines the color complexity by obtaining the weighted color map and analyzing the variance of weighted color map. Further, the object complexity analyzer (113) determines the edge complexity by obtaining the weighted edge map and analyzing the variance of weighted edge map. Further, the object complexity analyzer (113) estimates the geometry complexity of object by applying color tracing starting with the user interaction coordinates. Further, the object complexity analyzer (113) utilizes the complexity analysis (color complexity, edge complexity and geometry complexity) to determine the optimal architecture of the interactive segmentation engine (114), and provides the complex supervision image output as additional input to the interactive segmentation engine (114).

FIGS. 5B-5D illustrate outputs of the color complexity analyzer (113A), the edge complexity analyzer (113B), and the geometry complexity analyzer (113C), according to an embodiment of the disclosure. As shown in FIG. 5B, in an example case in which the color complexity of the object in the image is high, the interactive segmentation engine (114) selects more layers for the NN model to segment the object in the image. In an example case in which the color complexity of the object in the image is low, the interactive segmentation engine (114) selects less layers for the NN model to segment the object in the image.

As shown in FIG. 5C, in an example case in which the edge complexity of the object in the image is high, the interactive segmentation engine (114) selects more channels for the NN model to segment the object in the image. In an example case in which the edge complexity of the object in the image is low, the interactive segmentation engine (114) selects less channels for the NN model to segment the object in the image.

The higher color complexity objects require more processing in deeper layers; therefore a high color complexity object need more layers. In an example case in which n layers are used for low complexity, n+α (α>=1) for high complexity object image may be used. Here, n is n integer. The low color complexity objects require less processing in deeper layers; therefore a low color complexity object can be segmented with less layers. The higher edge complexity objects require more feature understanding, therefore need more channels in each layer. In an example case in which k channels are used for low complexity, k+β (β>=1) for high complexity object image may be used. Here, k is n integer. The low edge complexity objects require less feature processing, therefore can be segmented with less channels in each layers.

As shown in FIG. 5D, in an example case in which the span of the object in the image is large, the interactive segmentation engine (114) chooses a greater number of scales of the image to segment the object in the image. In an example case in which the edge complexity of the object in the image is small, the interactive segmentation engine (114) selects a smaller number of scales of the image to segment the object in the image.

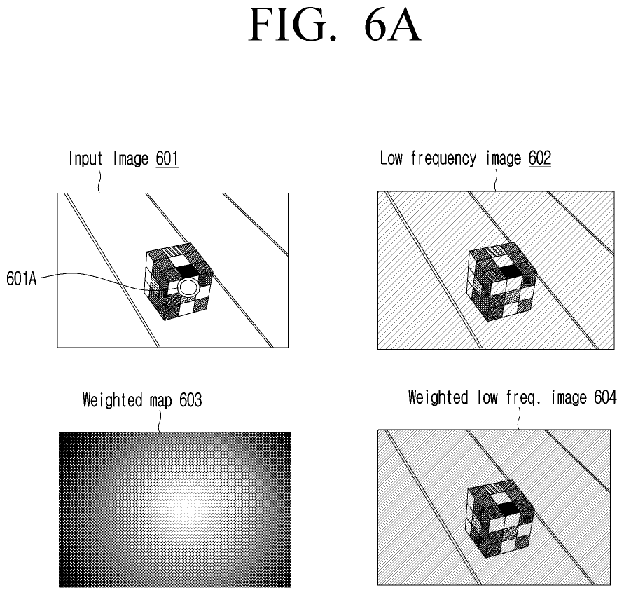

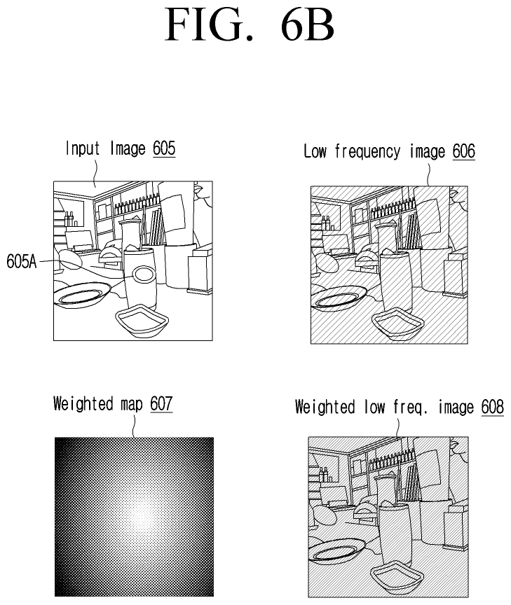

FIGS. 6A and 6B illustrate example scenarios of determining the weighted low frequency image, according to an embodiment of the disclosure. With reference to the FIG. 6A, consider an input image (601). Item 601A represents the user input on the object (a cube) in the image (601) to segment. Item 603 represents the weighted map of the image (601) with the user input determined by the electronic device (100). Item 602 represents the low frequency image of the image (601) determined by the electronic device (100). Item 604 represents the weighted low frequency image of the image (601) determined by convolving the low frequency image (602) with the weighted map (603).

With reference to the FIG. 6B, consider an input image (605). Item 605A represents the user input on the object (a bottle) in the image (605) to segment. Item 607 represents the weighted map of the image (605) with the user input determined by the electronic device (100). Item 606 represents the low frequency image of the image (605) determined by the electronic device (100). 608 represents the weighted low frequency image of the image (605) determined by convolving the low frequency image (606) with the weighted map (607).

The electronic device (100) obtains the low frequency component (602, 606) of the input image (601, 605) by using a low pass filter. Further, the electronic device (100) converts the unified guidance map obtained using the interaction input to the weighted map (603, 607) by normalizing the unified guidance maps. Further, the electronic device (100) computes the weighted low frequency image (604, 608) by convolving the low frequency image (602, 606) with the weighted map (603, 607). Further, the electronic device (100) computes the standard deviation of the weighted low frequency image (604, 608) to analyze the color complexity. Low standard deviation represents less color complexity of the object in the image (601) and the high standard deviation represents high color complexity of the object in image (605).

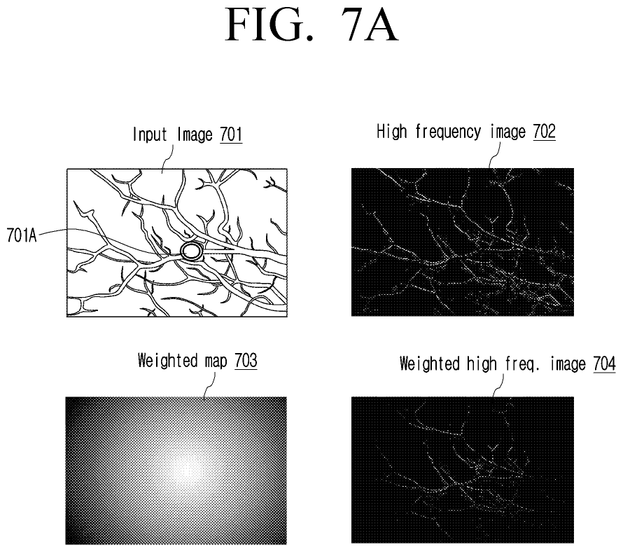

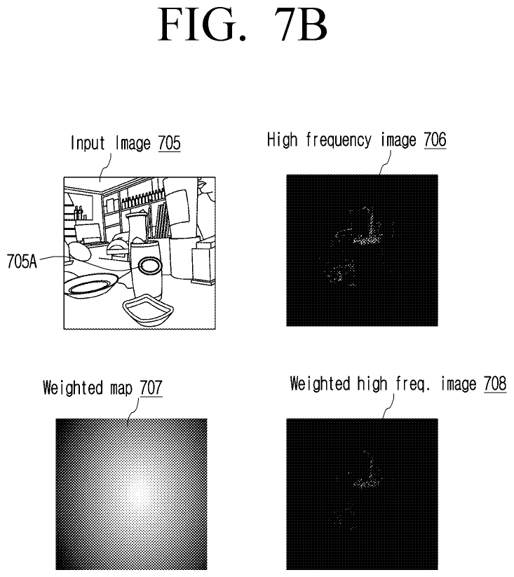

With reference to the FIG. 7A, consider an input image (701). Item 701A represents the user input on the object in the image (701) to segment. Item 703 represents the weighted map of the image (601) with the user input determined by the electronic device (100). Item 702 represents the high frequency image of the image (701) determined by the electronic device (100). Item 704 represents the weighted high frequency image of the image (701) determined by convolving the high frequency image (702) with the weighted map (703).

With reference to the FIG. 7B, consider an input image (705). Item 705A represents the user input on the object in the image (705) to segment. Item 707 represents the weighted map of the image (705) with the user input determined by the electronic device (100). Item 706 represents the high frequency image of the image (705) determined by the electronic device (100). Item 708 represents the weighted high frequency image of the image (605) determined by convolving the high frequency image (706) with the weighted map (707).

FIGS. 7A and 7B illustrate example scenarios of determining the weighted high frequency image, according to an embodiment of the disclosure. The electronic device (100) obtains the high frequency component (702, 706) of the input image (701, 705) by using a high pass filter. Further, the electronic device (100) converts the unified guidance map obtained using the interaction input to the weighted map (703, 707) by normalizing the unified guidance maps. Further, the electronic device (100) computes the weighted high frequency image (704, 708) by convolving the high frequency image (702, 706) with the weighted map (703, 707). Further, the electronic device (100) computes the standard deviation of the weighted high frequency image to analyze the edge complexity. Low standard deviation represents less edge complexity of the object in the image (705) and higher standard deviation represents high edge complexity of the object in the image (701).

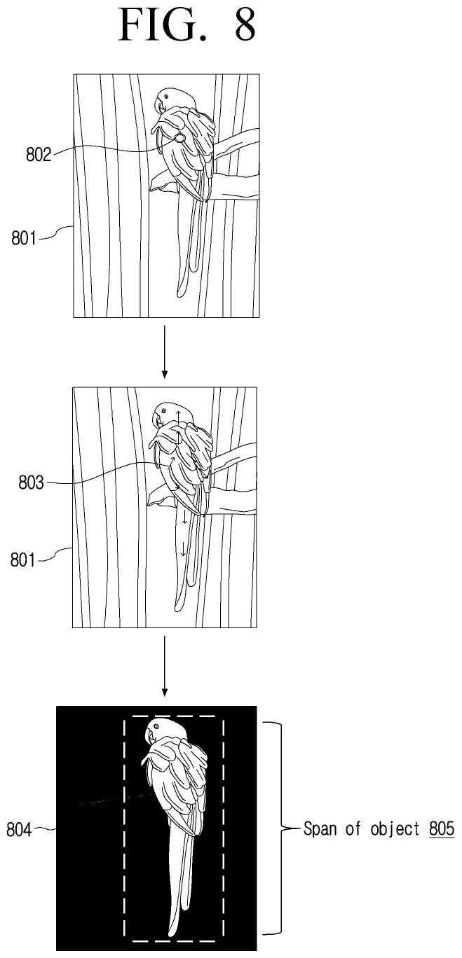

FIG. 8 illustrates example scenarios of determining the span of the object to segment, according to an embodiment of the disclosure. Upon detecting the user input to segment an object (e.g. parrot) in an image (801), the geometry complexity analyzer (113C) identifies the color at the location (802) on the image (801) where the user input is received. Further, the geometry complexity analyzer (113C) traces (803) (e.g. the flow of arrows) the color within the predefined range of color at the interaction location (802). For example, the color tracing may output an estimated binary map of the object. Further, the geometry complexity analyzer (113C) obtains the geometry map (804) for an improved geometry estimation of the object. For example, the geometry map (804) may include the union of the traced color with the edge map of the object. Further, the geometry complexity analyzer (113C) estimates the span of the object (805) by determining the size of bounding box (e.g. dotted rectangle shaped white color box) of the object in the geometry map. For example, the span may refer to the larger side of the bounding box in the rectangle shape.

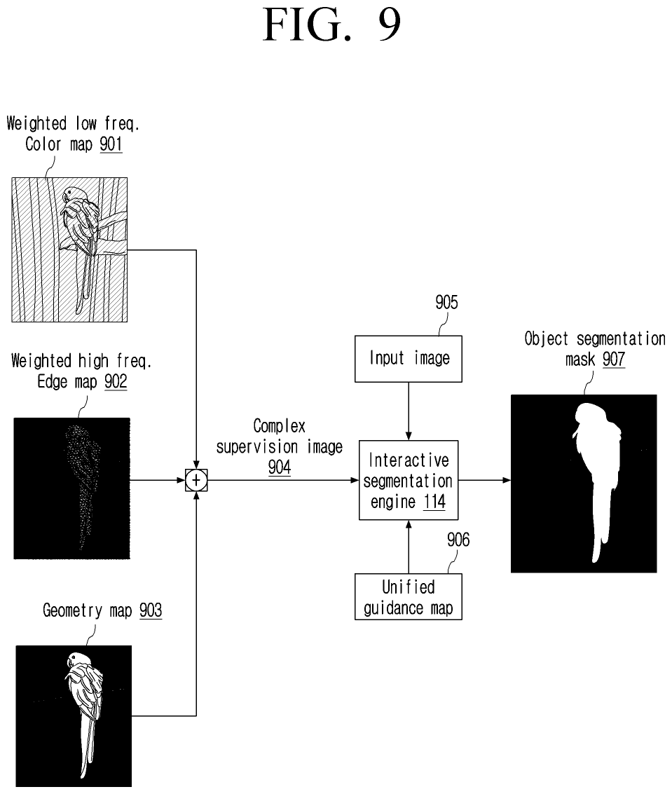

FIG. 9 illustrates example scenarios of determining the complex supervision image (904) based on the color complexity analysis, the edge complexity analysis and the geometry complexity analysis, according to an embodiment of the disclosure. In the color complexity analysis, the object complexity analyzer (113) determines the weighted low frequency color map (901), the weighted high frequency edge map (902), and the geometry map (903). Further, the object complexity analyzer (113) obtains the complex supervision image (904) by concatenating the weighted low frequency color map (901), the weighted high frequency edge map (902), and the geometry map (903). Further, the interactive segmentation engine (114) obtains the object segmentation mask (907) using the complex supervision image (904), the input image (905), and the unified guidance map (906).

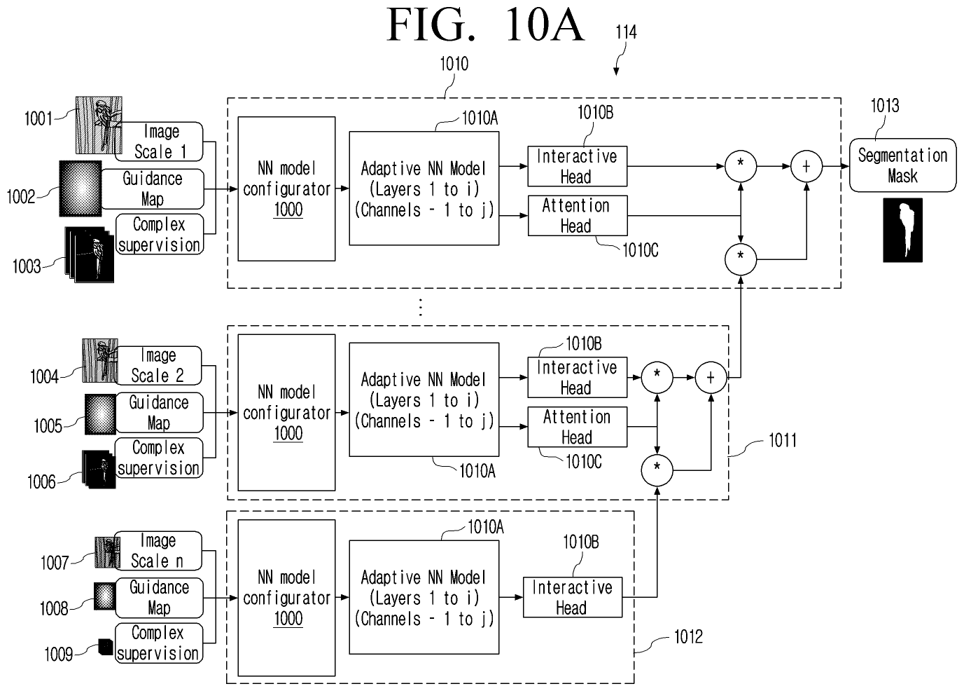

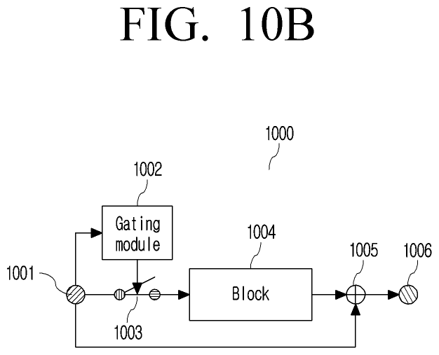

FIG. 10A illustrates a schematic diagram of creating the object segmentation mask, according to an embodiment of the disclosure. The interactive segmentation engine (114) includes multiple NN model units (1010-1012). Although three NN model units are illustrated, the disclosure not limited thereto, and as such, according to another embodiment, the number of NN model units may be different than three. Each NN model unit (1010-1012) includes a NN model configurator (1000), the adaptive NN model (1010A), and an interactive head (1010B). The NN model units (1010-1011) may further includes an attention head (1010C) except the last NN model unit (1012). The scaled image (1001), the guidance map (1002) of the scaled image (1001), the complex supervision image (1003) of the scaled image (1001) are the input of the NN model configurator (1000) of the NN model unit (1010). The NN model configurator (1000) of the NN model unit (1010) configures the layers and channels of the adaptive NN model (1010A) of the NN model unit (1010) based on the complexity parameters. The NN model configurator (1000) of the NN model unit (1010) provides the scaled image (1001), the guidance map (1002) of the scaled image, the complex supervision image (1003) to the of the scaled image to the adaptive NN model (1010A) of the NN model unit (1010). The interactive head (1010B), and the attention head (1010C) of the NN model unit (1010) receives the output of the adaptive NN model (1010A) of the NN model unit (1010). The electronic device (100) determines a first product of the outputs of the interactive head (1010B), and the attention head (1010C) of the NN model unit (1010). Further, the electronic device (100) concatenates the first product with a second product of the output of the attention head (1010C) of the NN model unit (1010) and the output of the next NN model unit (1011).

The last NN model unit (1012) includes the NN model configurator (1000), the adaptive NN model (1010A), and the interactive head (1010B). The scaled image (1007), the guidance map (1008) of the scaled image (1007), the complex supervision image (1009) of the scaled image (1007) are the input of the NN model configurator (1000) of the last NN model unit (1012). The NN model configurator (1000) of the last NN model unit (1012) configures the layers and channels of the adaptive NN model (1010A) of the last NN model unit (1012) based on the complexity parameters. The NN model configurator (1000) of the last NN model unit (1012) provides scaled image (1007), the guidance map (1008) of the scaled image (1007), the complex supervision image (1009) of the scaled image (1007) to the adaptive NN model (1010A) of the last NN model unit (1012). The interactive head (1010B) of the last NN model unit (1012) receives the output of the adaptive NN model (1010A) of the last NN model unit (1012). The electronic device (100) provides the output of the interactive head (1010B) of the last NN model unit (1012) to determine the second product with the output of the attention head (1010C) of the previous NN model unit (1011) of the last NN model unit (1012).

FIG. 10B illustrates an exemplary configuration of the NN model configurator (1000), according to an embodiment of the disclosure. The exemplary configuration of the NN model configurator (1000) includes an input terminal (1001), a gating module (1002), a switch (1003), a block (1004), a concatenation node (1005), and an output terminal (1006). The input terminal (1001) is connected to the gating module (1002), the switch (1003), and the concatenation node (1005). The gating module (1002) controls a switching function of the switch (1003). For example, the gating module (1002) may control the connection of the input terminal (1001) with the block (1004) through the switch (1003). Based on predefined ranges of the complexity analysis parameters, the gating modules are arranged to enable or disable an execution of certain layers/channels of the NN model based on the complexity parameter. The input terminal (1001) and an output of the block (1004) are concatenated at the concatenation node (1005) to provide an output of the NN model configurator (1000) at the output terminal (1006).

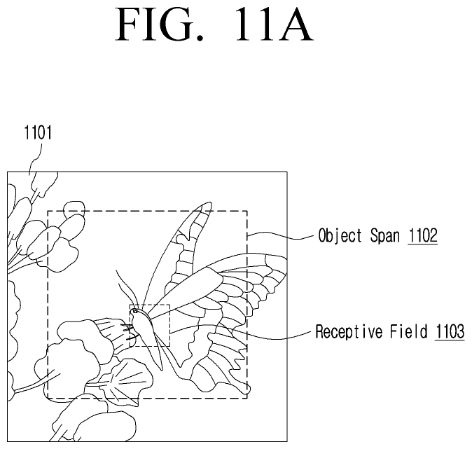

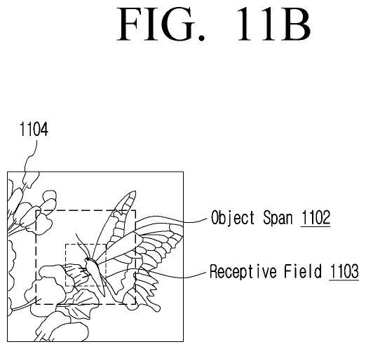

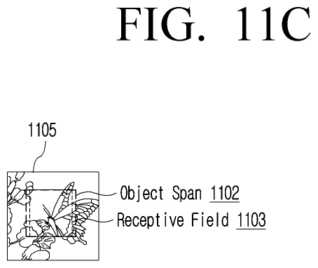

FIGS. 11A-11C illustrate an example scenario of adaptively determining the number of scales in the hierarchical network (i.e. NN model) based on the span of the object to be segmented, according to an embodiment of the disclosure. Consider, the input image shown in 1101 received by the electronic device (100) to segment the object. Upon receiving the image, the geometry complexity analyzer (113C) determines the number of scales such that at the last scale, a receptive field of the hierarchical network becomes greater than or equal to the object span (1102). According to an embodiment, x may be the receptive field (1103) of the network (in pixels) and y may be the object span (1102) (in pixels)

At each scale (1104, 1105), the image is down sampled by a factor 2, therefore the receptive field doubles at that scale. The geometry complexity analyzer (113C) makes the receptive field (x)>=object span (y), i.e. 2n*x=y, i.e. n=log 2 (y/x), where n+1 represents the number of scales to be used.

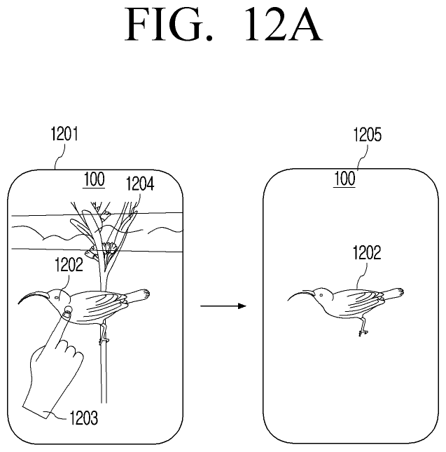

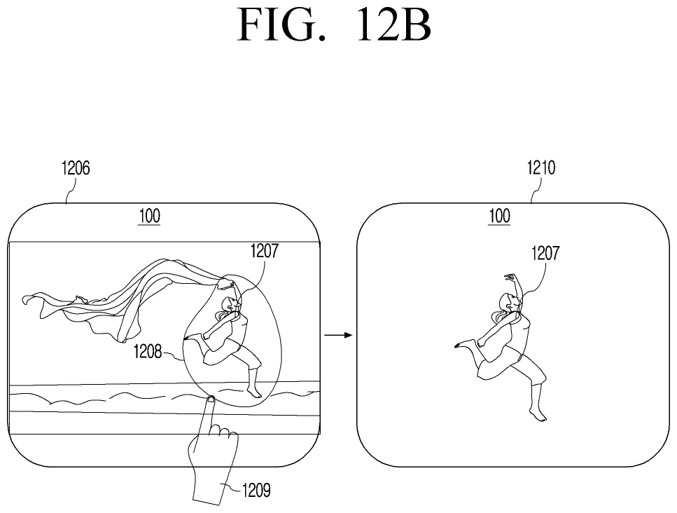

FIGS. 12A and 12B illustrate example scenarios of the interactive image segmentation, according to an embodiment of the disclosure.

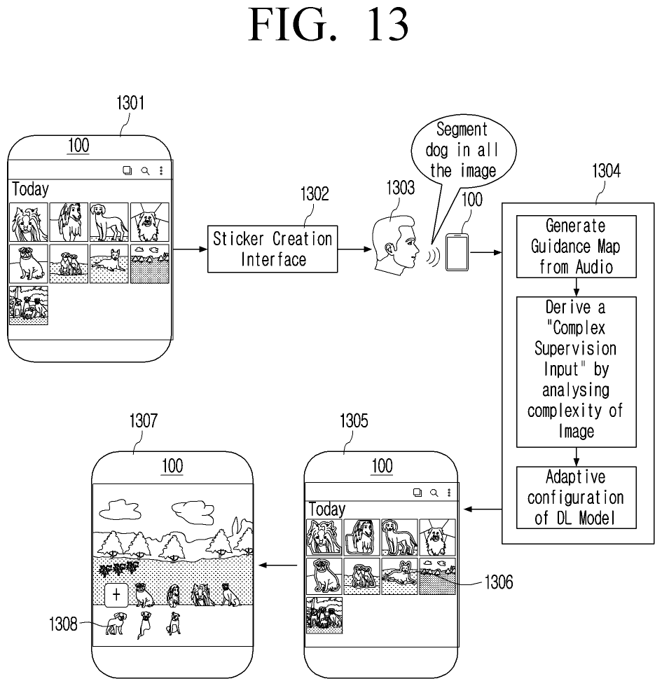

FIGS. 13-16 illustrate example scenarios of the interactive image segmentation, according to an embodiment of the disclosure.

FIG. 12A illustrates an example scenario in which the user (1203) provides the touch input on a first object (1202) (e.g., a bird) to segment from an image (1201) displayed on the electronic device (100). The image may include a second object (1204). In FIG. 12A, the bird (the first object 1202) is standing on a tree (the second object 1204) in the image 1201. Upon receiving the user input on the first object (1202), the electronic device (100) segments only the bird (1202) as shown in image (1205).

FIG. 12B illustrates an example scenario in which the user (1209) draws a contour (1208) around an object (1207) (i.e. a lady) to segment from an image (1206) displayed on the electronic device (100). In FIG. 12B, the lady (1207) is dancing in the image (1206). Upon receiving the user input on the object (1207), the electronic device (100) segments only the object (1207) (e.g., the lady) as shown in image (1210). With the framework for interactive image segmentation according to one or more embodiments of the disclosure, the user is able to select and crop an object. The extracted object can be used as sticker for sharing via messaging. However, the disclosure is not limited thereto, and as such, according to another embodiment, the extracted object may be applied to other scenarios. For example, the extracted object may be applied for image editing and/or video editing operations.

With reference to the FIG. 13, consider the user wants to create virtual stickers of dogs using the images stored in a smartphone (i.e. electronic device (100)) as shown in 1301. The user opens the sticker creation interface (1302) in the smartphone (100), and provides the voice input “Segment dog in all the image” to the smartphone (100). At 1304, the smartphone (100) receives the user interaction on the object and identifies the objects in the images stored in smartphone (100) to segment using the method according to one or more embodiments of the disclosure. Further, the smartphone (100) segments the images (1306) of the dogs from the images stored in smartphone (100) using the method according to one or more embodiments of the disclosure as shown in 1305. Further, the smartphone (100) creates virtual stickers (1308) of the dogs segmented from the images stored in smartphone (100) as shown in 1307.

Thus, the method according to one or more embodiments of the disclosure can be used for audio/text based user interaction that can be used to create multiple stickers simultaneously. The smartphone (100) identifies multiple image having desired category objects to be segmented, and single image with multiple desired category objects. Single voice command can be used to improve segmentation on particular object category across multiple images in gallery. For example “Dog” can suffice for-> “Dog Sitting”, “Dog Running”, “Dog Jumping”, “Large Dog”, “Small Dog” etc.

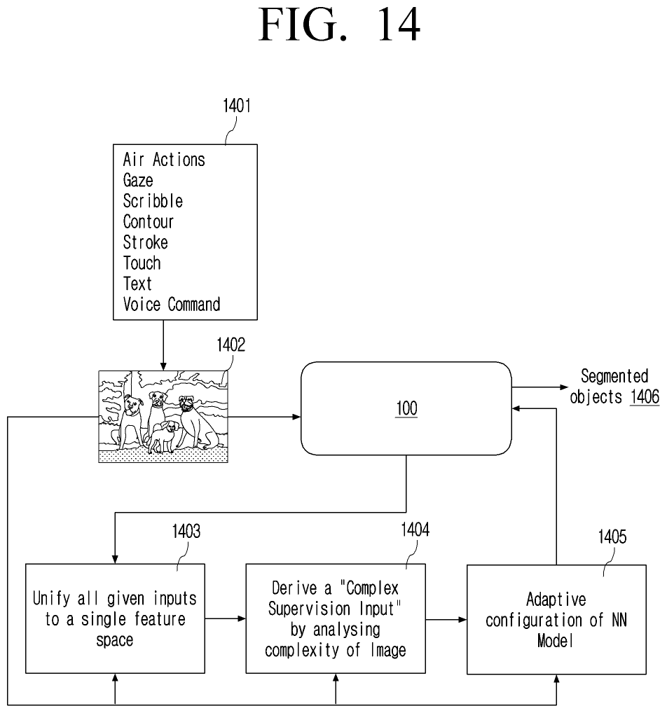

With reference to the FIG. 14, consider the user provides multiple user inputs (1401) to the electronic device (100) to segment the object in the image as shown in 1402. At 1403, the electronic device (100) unifies all given inputs to a single feature space. At 1404, the electronic device (100) derives a “complex supervision input” by analyzing complexity of the image and the unified given inputs. At 1405, the electronic device (100) adaptively configures the NN model and segments the object from the image at 1406.

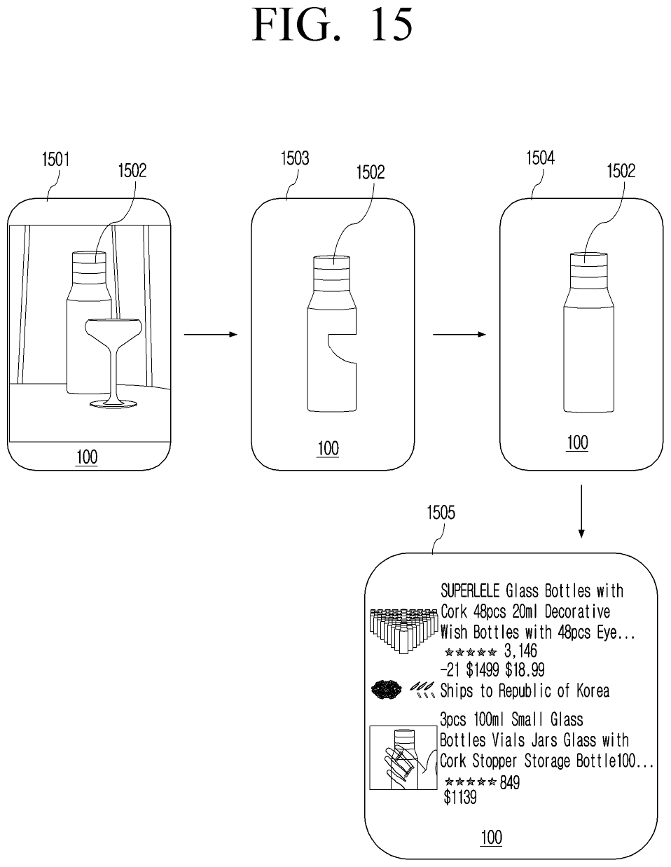

With reference to the FIG. 15, consider the user provides multiple user inputs (1401) to the electronic device (100) to segment the object (bottle (1502)) in the image as shown in 1501, the inputs can be the touch input, the audio input, the eye gaze, etc. The electronic device (100) extracts the object (1502) from the complex image as shown in 1503. Upon extracting the incomplete image of the bottle (1502), the electronic device (100) performs inpainting on the incomplete image of the bottle (1502) and recreated the complete image of the bottle (1502) as shown in 1504. Further, the electronic device (100) performs image searches on the E-commerce websites using the complete image of the bottle (1502) and performs inpainting on the incomplete image of the bottle (1502) and provides search results to the user as shown in 1505.

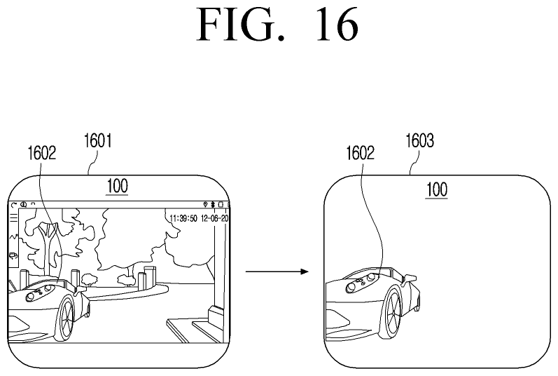

With reference to the FIG. 16, consider the user provides the voice input “segment car” to the electronic device (100) while watching a video of a car (1602) and few background details in the electronic device (100) as shown in 1601. The electronic device (100) identifies unwanted objects in current frame of the video and remove those unwanted objects from all subsequent frames of the videos, thus displays only scenes of the car in the video as shown in 1603.

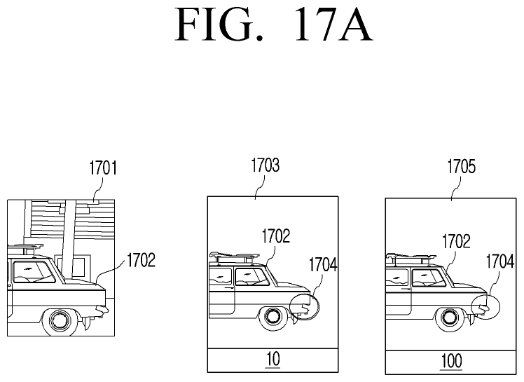

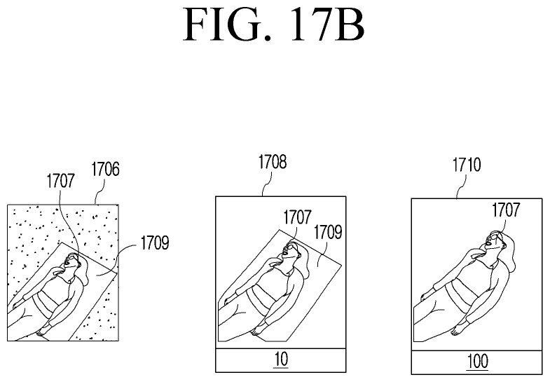

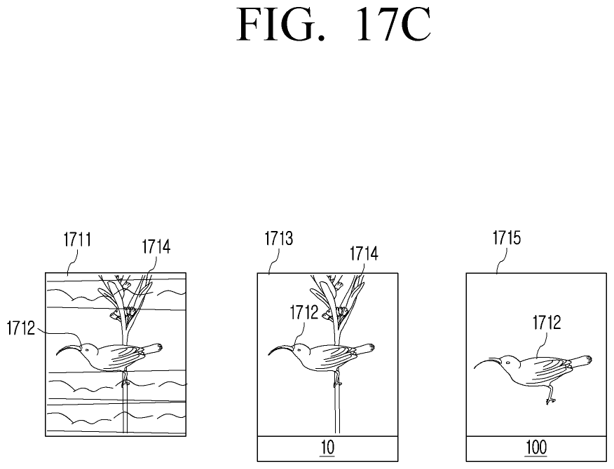

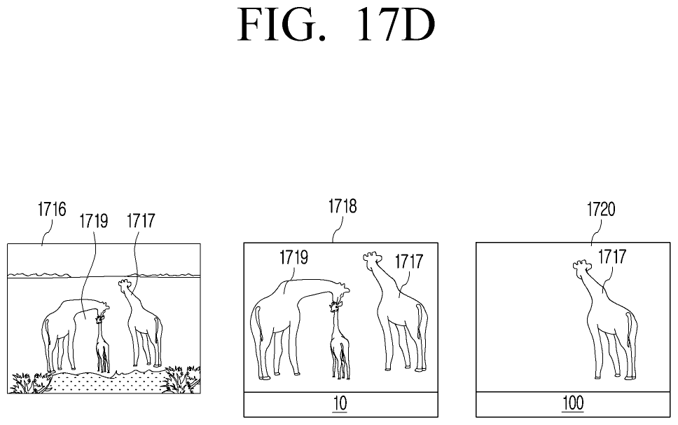

FIGS. 17A-17D illustrate comparison of segmentation results from a related art method with the interactive image segmentation results from a method according to an embodiment of the disclosure. With reference to the FIG. 17A, a car (1702) is the object to segment from the image (1701). Upon receiving the user input on the object (1702), a related art electronic device (10) segments the object (1702) by missing a portion (1704) of the object (1702) as shown in image 1703, which deteriorates user experience. Unlike the related art electronic device (10), upon receiving the user input on the object (1702), the electronic device (100) according to an embodiment segments the object (1702) completely as shown in image 1704 which improves user experience.

With reference to the FIG. 17B, a lady (1707) is the object to segment from the image (1706), where the lady (1707) is laying on a mattress (1709) in the image (1706). Upon receiving the user input on the object (1707), the related art electronic device (10) considers the lady (1707) and the mattress (1709) as the target object and segments both the lady (1707) and the mattress (1709) as shown in image 1708 which deteriorates user experience. Unlike the related art electronic device (10), upon receiving the user input on the object (1707), the electronic device (100) according to an embodiment segments only the lady (1707) as shown in image 1710 which improves user experience.

With reference to the FIG. 17C, a bird (1712) is the object to segment from the image (1711), where the bird (1712) is standing on a tree (1714) in the image (1711). Upon receiving the user input on the object (1712), the related art electronic device (10) considers the bird (1712) and the tree (1714) as the target object and segments both the bird (1712) and the tree (1714) as shown in image 1713 which deteriorates user experience. Unlike the related art electronic device (10), upon receiving the user input on the object (1712), the electronic device (100) according to an embodiment segments only the bird (1712) as shown in image 1715 which improves user experience.

With reference to the FIG. 17D, a giraffe (1717) is the object to segment from the image (1716), where the giraffe (1717) is standing near to other giraffes (1719) in the image (1716). Upon receiving the user input on the object (1717), the related art electronic device (10) considers the giraffe (1717) and other giraffes (1719) as the target object and segments all giraffes (1717, 1719) as shown in image 1718 which deteriorates user experience. Unlike the related art electronic device (10), upon receiving the user input on the object (1717), the electronic device (100) according to an embodiment segments only the giraffe (1717) as shown in image 1720 which improves user experience.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of example embodiments, those skilled in the art will recognize that the embodiments herein can be practiced with modification within the scope of the embodiments as described herein.

What is claimed is:

1. A method for interactive image segmentation by an electronic device, the method comprising: receiving one or more user inputs for segmenting at least one object from among a plurality of objects in an image;
generating a unified guidance map that indicates the at least one object to be segmented based on the one or more user inputs;
generating a complex supervision image based on the unified guidance map;
segmenting the at least one object from the image by inputting the image, the complex supervision image and the unified guidance map into an adaptive Neural Network (NN) model; and
storing the at least one segmented object from the image.

2. The method as claimed in claim 1, wherein the generating the unified guidance map comprises:
extracting input data based on the one or more user inputs;
obtaining one or more guidance maps corresponding to the one or more user inputs based on the input data; and
generating the unified guidance map by concatenating the one or more guidance maps.

3. The method as claimed in claim 2, wherein the obtaining the one or more guidance maps comprises:
based on the input data comprising one or more set of coordinates, obtaining traces of the one or more user inputs on the image using the input data; and
encoding the traces into the one or more guidance maps, and
wherein the traces represent user interaction locations on the image.

4. The method as claimed in claim 2, wherein the obtaining the one or more guidance maps comprises:
based on the input data comprising text indicating the at least one object in the image, determining a segmentation mask based on a category of the text using an instance model; and
converting the segmentation mask into the one or more guidance maps.

5. The method as claimed in claim 4, wherein the determining the segmentation mask comprises:
based on the input data comprising an audio, converting the audio into the text; and
determining the segmentation mask based on the category of the text using the instance model.

6. The method as claimed in claim 1, wherein the generating the complex supervision image comprises:
determining a plurality of complexity parameters comprising at least one of a color complexity, an edge complexity or a geometry map of the at least one object to be segmented; and
generating the complex supervision image by concatenating a weighted low frequency image obtained using the color complexity and the unified guidance map, a weighted high frequency image obtained using the edge complexity and the unified guidance map, and the geometry map.

7. The method as claimed in claim 6, wherein the determining the color complexity of the at least one object comprises:
obtaining a low frequency image by inputting the image into a low pass filter;
determining a weighted map by normalizing the unified guidance map;
determining a weighted low frequency image by convolving the low frequency image with the weighted map;
determining a standard deviation of the weighted low frequency image;
determining whether the standard deviation of the weighted low frequency image is greater than a first threshold; and
performing one of:
detecting that the color complexity is high, based on the standard deviation of the weighted low frequency image being greater than the first threshold, and
detecting that the color complexity is low, based on the standard deviation of the weighted low frequency image being less than or equal to the first threshold.

8. The method as claimed in claim 6, wherein the determining the edge complexity of the at least one object comprises:
obtaining a high frequency image by inputting the image into a high pass filter;
determining a weighted map by normalizing the unified guidance map;
determining a weighted high frequency image by convolving the high frequency image with the weighted map;
determining a standard deviation of the weighted high frequency image for analyzing the edge complexity;
determining whether the standard deviation of the weighted high frequency image is greater than a second threshold; and
performing one of:
detecting that the edge complexity is high, based on the standard deviation of the weighted high frequency image being greater than the second threshold, and
detecting that the edge complexity is low, based on the standard deviation of the weighted high frequency image being less than or equal to the second threshold.

9. The method as claimed in claim 6, wherein the determining the geometry map of the at least one object comprises:
identifying a color at a location on the image;
tracing the color within a reference range of color at the location;
obtaining the geometry map comprising a union of the traced color with an edge map of the at least one object; and
estimating a span of the at least one object by determining a size of a bounding box of the at least one object in the geometry map, and
wherein the span corresponds to a larger side of the bounding box in a rectangle shape.

10. The method as claimed in claim 1, wherein the segmenting the at least one object from the image comprises:
determining optimal scales for the adaptive NN model based on a relationship between a receptive field of the adaptive NN model and a span of the at least one object;
determining an optimal number of layers for the adaptive NN model based on a color complexity;
determining an optimal number of channels for the adaptive NN model based on an edge complexity;
configuring the adaptive NN model based on the optimal scales, the optimal number of layers, and the optimal number of channels; and
segmenting the at least one object from the image by inputting the image, the complex supervision image, and the unified guidance map through the configured adaptive NN model.

11. The method as claimed in claim 10, wherein the determining the optimal scales comprises:
downscaling the image by a factor of two until the span of matches to the receptive field; and
determining the optimal scales for the adaptive NN model based on a number of times the image has been downscaled to match the span with the receptive field.

12. The method as claimed in claim 10, wherein the determining the optimal number of layers comprises:
performing one of:
selecting a default number of layers as the optimal number of layers based on detecting a first color complexity in the image, and
adding a reference layer offset value with the default number of layers for obtaining the optimal number of layers based on detecting a second color complexity, and
wherein the first color complexity is lower than the second color complexity.

13. The method as claimed in claim 10, wherein the determining the optimal number of channels comprises:
performing one of:
selecting a default number of channels as the optimal number of channels based on detecting a first edge complexity, and
adding a reference channel offset value with the default number of channels for obtaining the optimal number of channels based on detecting a second edge complexity, and
wherein the first edge complexity is lower than the second edge complexity.

14. A method for encoding different types of user interactions by an electronic device, the method comprising:
detecting a plurality of user inputs performed on an image;
obtaining a plurality of guidance maps by converting each of the plurality of user inputs to one of the plurality of guidance maps based on a type of the respective user input;
unifying the plurality of guidance maps to generate a unified guidance map representing a unified feature space;
determining an object complexity based on the unified guidance map and the image; and
inputting the object complexity and the image to an interactive segmentation engine.

15. The method as claimed in claim 14, wherein the type of the user inputs is at least one of a touch, a contour, a scribble, a stroke, text, an audio, an eye gaze, or an air gesture.
